(19) United States
(12) Patent Application Publication
(10) Pub. No.: US 2006/0107246 A1
(43) Pub. Date: May 18, 2006

(54) Designing method for high-frequency transistor and high-frequency transistor having multi-finger gate

(76) Inventor: Akihiro Nakamura, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/267,993

(22) Filed: Nov. 7, 2005

(30) Foreign Application Priority Data
Nov. 18, 2004 (JP) P2004-334267

(51) Int. Cl. G06F 17/50

(52) U.S. Cl. 716/5

(57) ABSTRACT

The present invention provides a designing method for a high-frequency transistor, which includes a transistor section, a drain region, and a gate electrode, a source wiring line, a drain wiring line, and a gate wiring line, for optimizing wiring lines and contacts from voltage supplying nodes to electrode lead nodes. The method includes the steps of measuring a sensitivity to a high-frequency characteristic of the high-frequency transistor regarding coupling capacities between the wiring lines and coupling capacities between the wiring lines and the semiconductor substrate from among equivalent circuit parameters which vary in response to a configuration of the wiring lines and the contacts; deciding layered levels individually of the gate wiring line, source wiring line, and drain wiring line based on the measured sensitivities; and designing patterns of the gate wiring line, source wiring line, and drain wiring line in the individually decided layered levels and the positions and the sizes of the wiring lines and the contacts for connecting the wiring lines and the transistor section to each other.

### CROSS REFERENCES TO RELATED APPLICATIONS

The present invention contains subject matter related to Japanese Patent Application JP 2004-334267 filed in the Japanese Patent Office on Nov. 18, 2004, the entire contents of which being incorporated herein by reference.

### BACKGROUND OF THE INVENTION

This invention relates to a designing method for a high-frequency transistor for optimizing wiring lines to electrode lead nodes and contacts of a transistor unit of a high-frequency semiconductor circuit and a high-frequency transistor having a multi-finger gate.

In recent years, it has become possible to obtain, in fine CMOS techniques, a characteristic of a current gain cutoff frequency ft which exceeds 100 GHz. Therefore, a CMOS transistor has begun to be used for high-frequency communication by a wireless LAN, the Bluetooth, or the like in place of an MESFET or a bipolar transistor in related art for which 3-5 group semiconductors (GaAs, InP) are used.

For the CMOS transistor, not only cost reduction but also improvement of a frequency characteristic using a high current gain cutoff frequency ft and a high maximum oscillation frequency fmax are proceeding. Further, a CMOS transistor circuit has various advantages that high integration of a digital circuit can be easily implemented and the digital circuit can coexist with an analog circuit, and an SOC (System On a Chip) technique can be utilized. From the reasons described, the CMOS transistor is applied to a high-frequency circuit which operates with a comparatively low frequency, and use of the CMOS transistor for a circuit which manages a higher frequency is being examined.

In design of a high-frequency circuit for mobile communication, specifications with regard to power consumption and noise are strict, and a circuit design technique based on highly accurate characteristic prediction is demanded. Accordingly, in order to place a high-frequency CMOS semiconductor circuit into practical use, it is important to predict a transistor characteristic in a high frequency with a high degree of accuracy.

In a field of such a high-frequency transistor as described above, in order to assure a high current driving capacitance and a high high-frequency characteristic (current gain cutoff frequency ft mentioned hereinabove or the like and a noise characteristic), a high-frequency transistor having a finger gate is used.

The “finger gate” is a gate electrode having a plane pattern wherein several tens to one hundred and several tens gate finger portions which function as effective gate portions are disposed in a juxtaposed relationship with and substantially in parallel to each other and coupled to each other on one end side or both end sides. A gate electrode wherein the gate finger portions are coupled with each other on one side is sometimes called comb-shaped gate.

In a high-frequency transistor having a finger gate, it is necessary to alternately dispose source regions and drain regions at a semiconductor substrate portion between the gate finger portions and electrically connect the source regions to each other and the drain impurity portions to each other by means of respective unique upper layer wiring lines to lead out the wiring lines as source wiring lines and drain wiring lines to the outside of the transistor unit. Further, also the gate electrode must be led out to the outside of the transistor unit by upper layer wiring lines. It is to be noted that the “transistor unit” is a generic term of a unit including not only a transistor section but also a gate wiring line, a drain wiring line, a source wiring line, and contacts for the wiring lines.

### SUMMARY OF THE INVENTION

In design of a transistor unit of a high-frequency semiconductor circuit, a high-frequency characteristic varies depending upon the layout. For the layout, a layout of a transistor section and a layout of a section (hereinafter referred to as wiring line section) which includes wiring lines and contacts and has a greater range in an upper layer than that of the transistor section.

Particularly in a high-frequency transistor having a finger gate, arising from a complicate shape of the gate electrode, the high-frequency characteristic is liable to be influenced much by a configuration of the wiring line section wherein the gate wiring line, drain wiring line, and source wiring line are led out. However, in design of a high-frequency transistor in related art having a finger gate, a pointer regarding what point should be taken notice of when the wiring line section is designed is not available. Accordingly, the actual condition is that very few proposal is available regarding a designing method for obtaining an optimum high-frequency characteristic.

Therefore, much labor is required particularly for layout change, and this makes design of a high-frequency transistor difficult.

It is desirable to provide a designing method for a high-frequency transistor wherein, when a layout of a wiring line section including wiring lines for a source, a drain, and a gate, contacts, or the like is to be changed, a high-frequency characteristic can be maintained or improved easily and effectively.

It is also desirable to provide a high-frequency transistor having a finger gate by which a high high-frequency characteristic can be achieved.

According to an embodiment of the present invention, there is provided a designing method for a high-frequency transistor, which includes a transistor section having a source region, a drain region, and a gate electrode which are formed on a semiconductor substrate, a source wiring line connected to the source region, a drain wiring line connected to the drain region, and a gate wiring line connected to the gate electrode, for optimizing wiring lines and contacts from voltage supplying nodes of the source region, the drain region and the gate electrode to electrode lead nodes of a transistor unit of a high-frequency semiconductor circuit. The method includes the steps of a measuring a sensitivity to a high-frequency characteristic of the high-frequency transistor regarding coupling capacities between the wiring lines including the gate wiring line, source wiring line, and drain wiring line and coupling capacities between the wiring lines and the semiconductor substrate from among equivalent circuit parameters which vary in response to a configuration of the wiring lines and the contacts, deciding layered levels individually of the gate wiring line, source wiring line, and drain wiring line based on the measured sensitivities, and designing patterns of the gate wiring line, source wiring line, and drain wiring line in the individually decided layered levels and the positions and the sizes of the wiring lines and the contacts for connecting the wiring lines and the transistor section to each other.

Preferably, where the drain wiring line is in an upper layer than that of the gate wiring line as a result of the decision at the level deciding step, a minimum dimension of a semiconductor fabrication process is applied to the dimension of the drain contact for connecting the drain wiring line to the drain region and the distance between the drain contact and the gate wiring line at the wiring line section designing step.

Preferably, where the coupling capacitance between the drain wiring line and the semiconductor substrate is to be reduced as a result of the measurement at the sensitivity measuring step, the layered levels of the wiring lines are decided at the level deciding step so that the drain wiring line is in an upper layer than that of the gate wiring line.

Where the coupling capacitance between the drain wiring line and the source wiring line is to be reduced as a result of the measurement at the sensitivity measuring step, the layered levels of the wiring lines may be decided at the level deciding step so that the layers of the source wiring line and the drain wiring line are different from each other.

Preferably, the designing method for a high-frequency transistor further includes the steps of designing the transistor section. At least one of a correction value for the resistance value of the semiconductor substrate and a correction value for the coupling capacitance between the drain wiring line and the semiconductor substrate is determined such that, under the coupling capacitance value between the drain wiring line and the semiconductor substrate used at the sensitivity measuring step, where power consumption has a maximum value in a series circuit of the coupling capacitance and the resistance of the semiconductor substrate, the power consumption decreases from the maximum value, and the determined correction value is reflected on at least one of the transistor designing step, sensitivity measuring step, and connection section designing step.

Preferably, at the sensitivity measuring step, the sensitivity of a layout parameter to the high-frequency characteristic is measured from a result of a simulation which is performed by variously changing the layout parameter using, as a high-frequency transistor model for representing the high-frequency transistor on a computer upon simulation of a high-frequency characteristic, a high-frequency transistor model which includes an intrinsic transistor section of the high-frequency transistor and a parasitic circuit which is connected to the intrinsic transistor section and includes the layout parameter which varies in response to change of the layout of the electrodes, wiring lines, and contacts of the transistor unit.

In this instance, the high-frequency transistor model may further include an extrinsic circuit which is connected to the intrinsic transistor section and includes a non-quasi-static parameter indicating a time delay of carriers traveling in a channel of the high-frequency transistor.

The parasitic circuit may include a coupling capacitance between the semiconductor substrate and the source wiring line, a coupling capacitance between the semiconductor substrate and the drain wiring line, in-substrate resistances and in-substrate capacitances from the coupling capacities to a reference potential of the semiconductor substrate, a coupling capacitance between the gate wiring line and the drain wiring line, and a coupling capacitance between the gate wiring line and the source wiring line.

Preferably, the gate-drain capacitance and the gate-source capacitance which are parameters of the intrinsic transistor section have a bias dependency.

In the designing method for a high-frequency transistor, attention is paid to coupling capacitances between the drain wiring line and different portions (semiconductor substrate, source wiring line, and gate wiring line) as parameters which have a significant influence on a high-frequency characteristic of the high-frequency transistor and besides can be changed readily. Then, the influence of the coupling capacitances on the high-frequency characteristic is estimated, and the layered levels of the wiring lines are decided appropriately based on a result of the estimation.

When the influence of the coupling coefficients on the high-frequency characteristic is estimated, although a simulation is performed usually, in the present invention, a high-frequency transistor model including layout parameters is used in the simulation as a more desirable method. In this instance, in what manner a result of change of the layered level of a wiring line or the like has an influence on the high-frequency characteristic is estimated by the change of the layout parameters and the simulation.

According to another embodiment of the present invention, there is provided a high-frequency transistor having a multi-finger gate, including a transistor section having a source region and a drain region as well as a gate electrode having multi-fingers, all formed on a semiconductor substrate, a source wiring line connected to the source region, a drain wiring line connected to the drain region, and a gate wiring line connected to the gate electrode, the drain wiring line being disposed in an upper layer than that of the gate wiring line while a minimum dimension of a semiconductor fabrication process is applied to the dimension of a drain contact for connecting the drain wiring line to the drain region and the distance between the drain contact and the gate wiring line in order to reduce a coupling capacitance between the drain wiring line and the semiconductor substrate.

According to a further embodiment of the present invention, there is provided a high-frequency transistor having a multi-finger gate, including a transistor section having a source region and a drain region as well as a gate electrode having multi-fingers, all formed on a semiconductor substrate, a source wiring line connected to the source region, a drain wiring line connected to the drain region, and a gate wiring line connected to the gate electrode, the drain wiring line being disposed in an upper layer than that of the gate wiring line in order to reduce a coupling capacitance between the drain wiring line and the gate wiring line.

According to a still further embodiment of the present invention, there is provided a high-frequency transistor having a multi-finger gate, including a transistor section having a source region and a drain region as well as a gate electrode having multi-fingers, all formed on a semiconductor substrate, a source wiring line connected to the source region, a drain wiring line connected to the drain region, and a gate wiring line connected to the gate electrode, the source wiring line and the drain wiring line being disposed in layers different from each other in order to reduce a coupling capacitance between the drain wiring line and the source wiring line.

According to a yet further embodiment of the present invention, there is provided a high-frequency transistor having a multi-finger gate, including a transistor section having a source region and a drain region as well as a gate electrode having multi-fingers, all formed on a semiconductor substrate, a source wiring line connected to the source region, a drain wiring line connected to the drain region, and a gate wiring line connected to the gate electrode, at least one of the resistance value of the semiconductor substrate and the coupling capacitance between each of the wiring lines and the semiconductor substrate being determined such that, under the coupling capacitance value between the gate wiring line, drain wiring line, or source wiring line and the semiconductor substrate, where power consumption has a maximum value in a series circuit of the coupling capacitance and the resistance of the semiconductor substrate, the power consumption decreases from the maximum value.

With the designing method for a high-frequency transistor, when the layout of the wiring line section such as a wiring line and a contact for the source, drain, or gate is changed, a high-frequency characteristic can be maintained or improved easily and effectively. Further, with the high-frequency transistors having a multi-finger gate, a high high-frequency characteristic can be achieved.

### BRIEF DESCRIPTION OF THE DRAWINGS

These and other objects of the invention will be seen by reference to the description, taken in connection with the accompanying drawings, in which:

FIG. 1 is an equivalent circuit diagram of a high-frequency transistor model according to an embodiment of the present invention;

FIG. 2 is a schematic view illustrating an NQS effect and showing couplings between a gate electrode and a channel and channel resistances in a high-frequency as distribution constants;

FIG. 3 is an equivalent circuit diagram showing a general configuration of an intrinsic transistor section which is represented as an equivalent circuit model;

FIGS. 4A to 4D are graphs of an S parameter showing a result of a simulation conducted using a high-frequency transistor model for comparison with actually measured values;

FIG. 5 is a graph illustrating a frequency characteristic of a gate resistance value extracted from an actual S parameter;

FIG. 6 is a circuit diagram showing extracted parameters necessary to suppress an influence of increase of an output resistance in a high-frequency upon characteristic adjustment by fitting in related art;

FIG. 7 is a Smith chart showing a locus of an output reflection coefficient in the circuit shown in FIG. 6;

FIG. 8 is a table illustrating a substrate resistance value (measurement value) determined by layout calculation and another substrate resistance value extracted after fitting of the S parameter for comparison;

FIG. 9 is a flow chart illustrating principle steps for deciding a parameter value upon production of a high-frequency transistor model;

FIG. 10 is a flow chart illustrating an outline of a re-production (updating) method of a model involved in layout change in production of a high-frequency transistor model;

FIG. 11A is a plan view of a first layout, FIG. 11B is a plan view of a second layout, and FIG. 11C is a table illustrating magnifications in parameter change involved in layout change;

FIGS. 12A and 12B are views illustrating particular values of non-layout dependent components taking a gate resistance and a substrate resistance as examples;

FIGS. 13A to 13D are Smith charts illustrating comparison between S parameter values calculated by a method according to the embodiment and actual measurement data;

FIG. 14 is a table illustrating results of sensitivity analysis in a production method for a high-frequency transistor model;

FIG. 15 is a top plan view of a high-frequency transistor having multi-fingers before design change in designing of a high-frequency transistor according to the embodiment of the present invention;

FIG. 16 is a schematic view showing a section taken along line A-A of FIG. 15;

FIG. 17 is a flow chart illustrating different steps of a designing method for a high-frequency transistor according to the embodiment of the present invention;

FIGS. 18 to 20 are sectional views showing different structure examples of the high-frequency transistor according to the embodiment of the present invention, respectively; and

FIG. 21 is an equivalent circuit diagram showing an equivalent circuit model which includes an extrinsic circuit for reproducing operation of a high-frequency transistor of the background art.

### DETAILED DESCRIPTION OF THE PREFERRED EMBODIMENTS

The designing method for a high frequency transistor according to an embodiment of the present invention can be applied irrespective of whether or not a high frequency transistor has a multi-finger gate. However, where the high frequency has a multi-finger gate, the coupling capacitance between wiring lines or between the wiring lines and the semiconductor substrate is more liable to increase than that in the case of an ordinary gate electrode (single-finger gate electrode) from the reason that the shape of the gate electrode is complicated and wiring lines are liable to cross with each other. Particularly when the layout is reduced or the number of fingers is changed, it is difficult to estimate in what manner the change of the coupling capacitances has an influence on high frequency characteristics, and this makes the design difficult. Accordingly, an embodiment of the present invention is applied preferably where a high frequency transistor having a multi-finger gate is designed.

Further, when the influence of the coupling capacitances on a high frequency characteristic is estimated, although a simulation is performed normally, since layout parameters varying depending upon the layout and the other parameters not varying depending upon the layout are not separated from each other in a heretofore MOS transistor model, the estimation is not ready for a layout change particularly of a wiring line section.

Therefore, in the design of a high frequency transistor having a multi-finger gate, it is most preferable to use, in the simulation, a high frequency transistor model provided with layout parameters newly proposed by the inventor of the present invention in order to raise the accuracy in prediction of the high frequency characteristics and facilitate the design.

In the following, an embodiment of the present invention is described taking the best mode thereof as an example. In the following description, a configuration of a layout-scalable high frequency transistor model is described first, and then, a method of producing the model and a method of re-producing the model upon layout change are described. Further, an optimization method of parameters is described, and finally, a configuration of a high frequency transistor having a finger gate and a method of designing the configuration, which are a direct embodiment of the present invention, are described.

<Example of the Configuration of a High-Frequency Transistor Model>

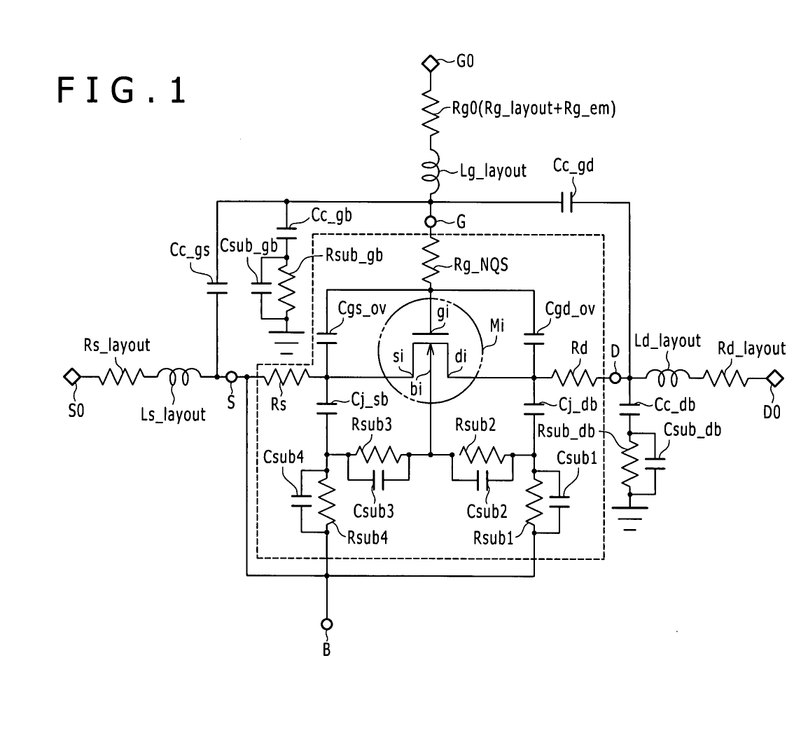

FIG. 1 shows a high-frequency transistor model wherein a source terminal and a back bias terminal are connected to each other. It is to be noted that the source terminal and the back bias terminal may not be connected to each other, and in this instance, a line which directly connects a source terminal S and a back bias terminal B shown in FIG. 1 to each other is omitted.

Referring to FIG. 1, the transistor model shown is formed from an intrinsic transistor section Mi, an extrinsic circuit, and a parasitic circuit.

The intrinsic transistor section Mi is a model of an active operation portion of a transistor provided, for example, by the “MSIM3 ver. 3 (Berkeley Short Channel IGFET Model 3 version 3)” and “MSIM4” developed by the University of California, Berkeley, United States, the “MOS model 9 (trademark)” provided by Philips Semiconductor, the “EKV” developed by EPFL (Electronics Laboratories, Swiss Federal Institute of Technology), Switzerland, and so forth.

The intrinsic transistor section Mi can be replaced by an equivalent circuit model which has parameter values such as, for example, a mutual conductance gm, a drain conductance gds, an intrinsic gate-drain capacitance Cgd_int, an intrinsic gate-source capacitance Cgs_int, and an intrinsic gate-substrate capacitance Cgb_int.

The intrinsic transistor section Mi has four internal contacts including a gate contact (hereinafter referred to as intrinsic gate node) gi, a drain contact (hereinafter referred to as intrinsic drain node) di, a source contact (hereinafter referred to as intrinsic source node) si, and a back bias contact (hereinafter referred to as intrinsic back bias node) bi.

A portion surrounded by a broken line framework in FIG. 1 except the intrinsic transistor section Mi indicates an extrinsic circuit.

The extrinsic circuit is connected to the intrinsic gate node gi, intrinsic drain node di, intrinsic source node si, and intrinsic back bias node bi of the intrinsic transistor section Mi and forms a network of passive parasitic elements included originally in the transistor. More particularly, the extrinsic circuit includes passive parasitic elements which form a substrate circuit of the high-frequency transistor and different passive parasitic elements which exhibit a non-quasi static effect (NQS) effect.

The extrinsic circuit includes, as the passive parasitic elements of the substrate circuit, a drain-substrate junction capacitance Cj_db (capacitance of a diode Dd), a source-substrate junction capacitance Cj_sb (capacitance of another diode Ds), and four substrate resistances connected between the intrinsic back bias node bi and the back bias terminal B, that is, a drain substrate resistance Rsub1, source-drain substrate resistances Rsub2 and Rsub3, and a source substrate resistance Rsub4. In the following description, the four resistances are referred to merely as “substrate resistances”. Substrate capacitances Csub1, Csub2, Csub3, and Csub4 are connected in parallel to corresponding ones of the four substrate resistances Rsub1 to Rsub4 as seen in FIG. 1.

Further, the extrinsic circuit includes a source resistance Rs, a drain resistance Rd, an overlap coupling capacitance Cgs_ov between the gate and the source, and an overlap coupling capacitance Cgd_ov between the gate and the drain.

Furthermore, the extrinsic circuit includes an NQS gate resistance Rg_NQS as a passive parasitic element which exhibits an NQS effect.

The parasitic circuit is an element added newly by the present embodiment and is an equivalent circuit model wherein electrodes, wiring line structures, and contacts of a high-frequency transistor on the outer side of the extrinsic circuit, that is, in a transistor unit of a high-frequency semiconductor circuit, are represented approximately by passive parasitic elements.

The parasitic circuit is indicated by a portion other than the portion surrounded by the broken line in FIG. 1.

In particular, the passive elements included in the parasitic circuit include, as seen in FIG. 1, a gate resistance Rg0 and an inductance component Lg_layout of the gate wiring line connected in series together with the NQS gate resistance Rg_NQS between the intrinsic gate node gi and a gate lead terminal G0 of the transistor unit, a layout component Rs_layout of the resistance of the source wiring line and an inductance component Ls_layout of the source wiring line connected in series together with the source resistance Rs between the intrinsic source node si and a source lead terminal S0, and a layout component Rd_layout of the resistance of the drain wiring line and an inductance component Ld_layout of the resistance of the drain wiring line connected in series together with the drain resistance Rd between the intrinsic drain node di and a drain lead terminal D0 of the transistor unit.

Further, the parasitic circuit includes a gate wiring line-substrate coupling capacitance Cc_gb and a gate coupling substrate resistance Rsub_gb connected in series between the gate wiring line and a substrate reference potential, and a gate coupling substrate capacitance Csub_gb connected in parallel to the gate coupling substrate resistance Rsub_gb. Similarly, the parasitic circuit includes a drain wiring line-substrate coupling capacitance Cc_db and a drain coupling substrate resistance Rsub_db connected in series between the drain wiring line and the substrate reference potential, and a drain coupling substrate capacitance Csub_db connected in parallel to the drain coupling substrate resistance Rsub_db. Further, the parasitic circuit includes a gate-drain wiring line coupling capacitance Cc_gd between the gate wiring line and the drain wiring line and a gate-source wiring line coupling capacitance Cc_gs between the gate wiring line and the source wiring line.

The gate resistance Rg0 is the sum of a layout component Rg_layout of the gate resistance and an electric field effect component Rg_em given by a skin effect and so forth.

Here, the NQS effect and the NQS gate resistance Rg_NQS mentioned hereinabove are described a little particularly.

A phenomenon that saturation of the velocity of carriers traveling in a channel such as electrons in the case of an N-channel or holes in the case of a P-channel is reported. As refinement proceeds, the gate oxide film becomes thinner and the electric field in a vertical direction of the gate voltage becomes sufficiently strong. Therefore, velocity saturation appears with regard to the movement of carriers, and a phenomenon that the delay time in movement of carriers cannot be ignored appears in a high frequency. The delay in carrier movement arising from the velocity saturation is called NQS effect.

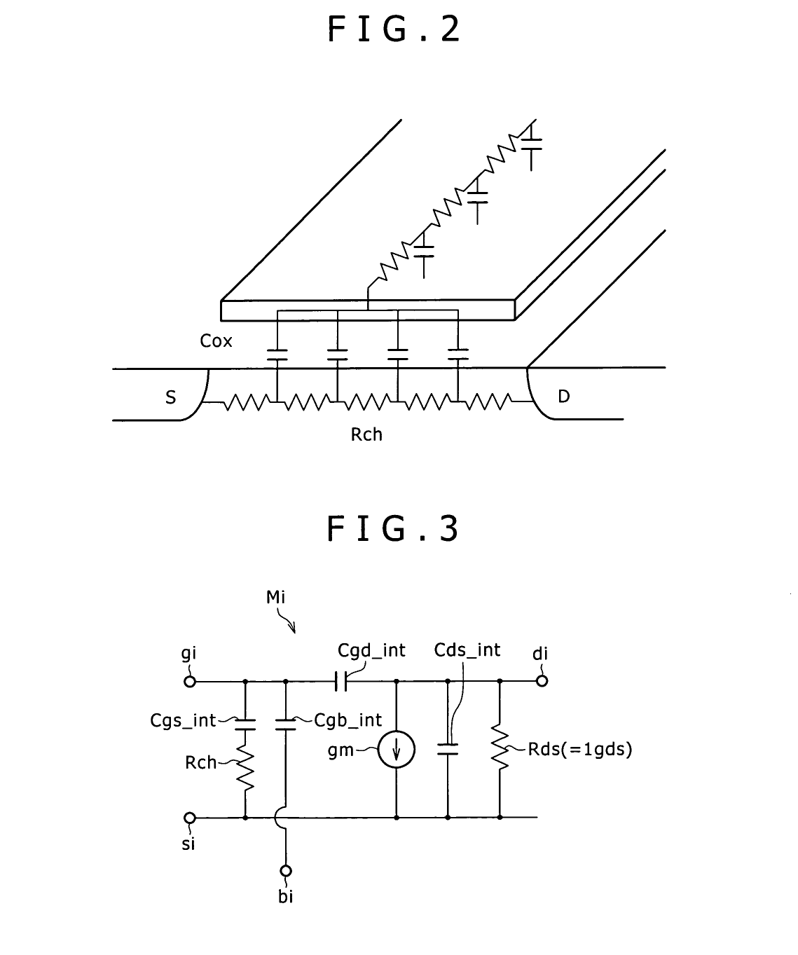

FIG. 2 illustrates coupling of the gate electrode and the channel in a high frequency and the channel resistance as distribution constants. Meanwhile, FIG. 3 shows a general configuration where the intrinsic transistor section Mi is an equivalent circuit model.

As seen from FIG. 2, in a high-frequency region, it is necessary to represent the coupling capacitance (principally oxide film capacitance Cox) between the gate electrode and the channel in a high frequency and the channel resistance Rch as distributed constants. In this instance, the time required to charge the capacitance Cox of the channel and the gate differs depending upon the place due to the time delay until carriers supplied from the source side arrive at the drain side, and this has an influence on the high-frequency operation of the device. Accordingly, as the gate length increases, the delay amount of electrons increases, and this has an influence on the device operation as an NQS effect.

An influence of the NQS effect appears with several parameters such as the channel resistance Rch, mutual conductance gm, and output resistance Rds (=1/gds) illustrated in FIG. 3 as parameters of an equivalent circuit of the intrinsic transistor section Mi. In a compact model in related art (BSIM3 ver. 3, EKV, or the like), the parameter values are fixed even if the frequency becomes high, and in a high frequency higher than a frequency at which the NQS effect appears, the behavior of an actual high-frequency transistor is displaced from the behavior in the case of a low frequency defined by parameter values.

In the compact model (BSIM3 ver. 3, EKV, or the like), an NQ mode in which an NQS effect is not adopted and an NQS mode in which an NQS effect is adopted are available, and operation in a low frequency is reproduced generally by the NQ mode.

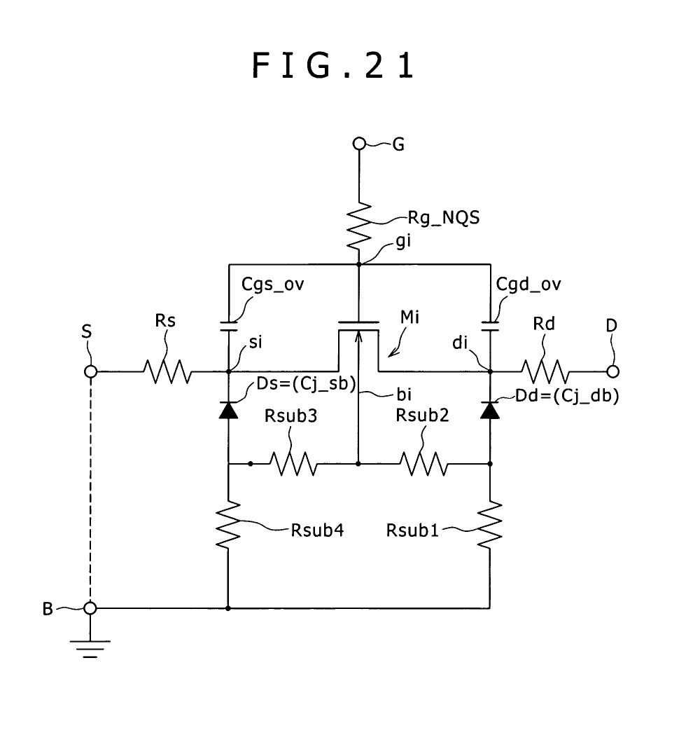

In the NQ mode, parameter values corresponding to actual physical amounts were set to the equivalent circuit in related art shown in FIG. 21, and the S parameter of the equivalent circuit was determined by a simulation. Further, the S parameter of an actual transistor corresponding to the equivalent circuit was measured, and the two S parameter values were compared with each other.

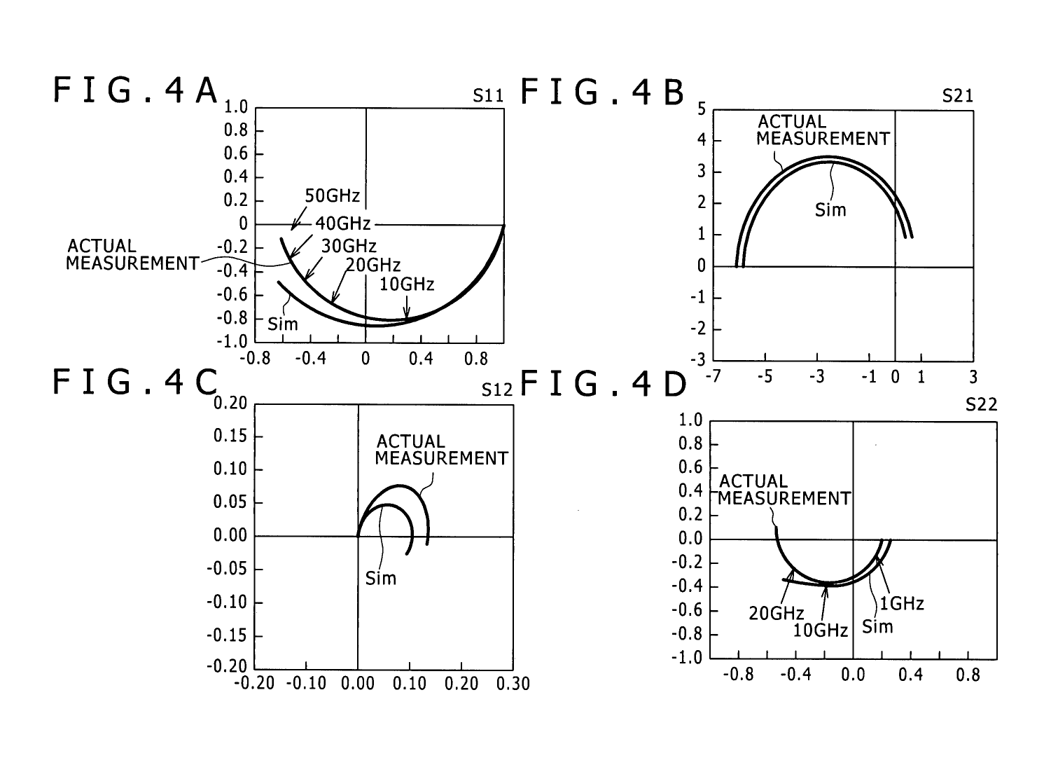

FIGS. 4A to 4D are graphs of the S parameter wherein the measured values and the simulation values (denoted by “Sim”) in this instance are compared with each other. From FIGS. 4A to 4D, it can be seen that a displacement in characteristic appears in a high frequency higher than approximately 10 GHz in the simulation based on the equivalent circuit in related art shown in FIG. 21. This is a displacement appears because the NQS effect is not adopted.

In compact models in related art, it has been proposed to add a distributed channel resistance as viewed from the gate in addition to the gate resistance Rg (sheet resistance of the gate electrode or the like) as a parasitic resistance to the gate of the input side in place of the channel resistance Rch (refer to FIG. 3) as a distributed constant in order to reproduce an NQS effect. Since the distributed channel resistance has been proposed by elmore, it is sometimes called “Delay of elmore” or “elmore resistance”.

From the reason described above, in the present embodiment, the gate electrode includes a component of the distributed channel resistance Rg_NQS (NQS gate resistance) as the elmore resistance to the gate electrode as shown in FIG. 1.

However, only if the NQS gate resistance Rg_NQS is added to the gate resistance representative of the sheet resistance of the gate electrode and the gate contact resistance, the deviation in comparison between the S parameters obtained by the simulation and actual measurement cannot be corrected accurately.

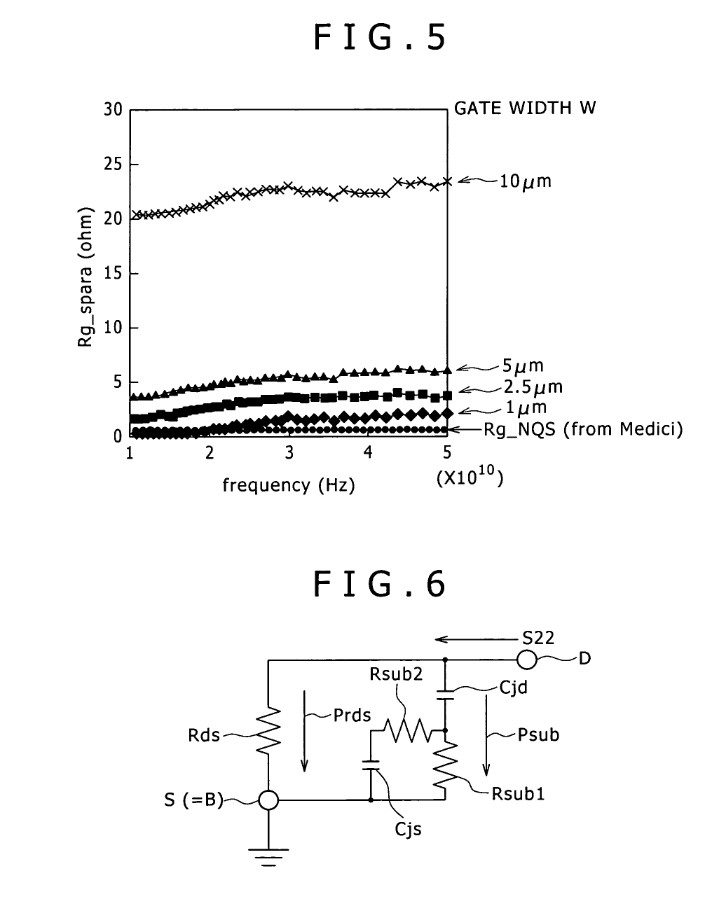

For example, a frequency characteristic of the value of the gate resistance extracted from an actual S parameter is illustrated in FIG. 5.

From FIG. 5, it can be seen that a gate resistance Rg_spara extracted from the S parameter increases as the frequency increases. It is considered that the cause of this is the increase of the resistance by a skin effect by an electromagnetic field effect. Therefore, it is necessary for reproduction of an accurate S parameter to take an influence of the electromagnetic field effect into consideration.

Therefore, as seen in FIG. 1, the gate resistance Rg0 of the parasitic circuit is represented by the sum of the layout component Rg_layout of the gate resistance calculated from the layout and including the sheet resistance of the gate electrode and the gate wiring line and the gate contact resistance, and the electric field effect component Rg_em by a skin effect and so forth. A particular example of the technique for separating the resistance components is hereinafter described.

In an actual device, the NQS gate resistance Rg_NQS and the electric field effect component Rg_em which arises from a skin effect and so forth increase as the operation frequency increases. Therefore, at least one, and preferably both, of the two parameters of the NQS gate resistance Rg_NQS and the electric field effect component Rg_em which arises from a skin effect and so forth, are provided with a frequency dependency. As a method of providing a frequency dependency, the parameter or parameters may be represented by a function of the frequency, or optimum values of each parameter for individual frequencies may be stored in advance as a table in a memory such that, if a frequency to be used is decided, then the optimum value of each parameter is read out in response to the frequency to automatically set a value of the NQS gate resistance Rg_NQS and/or the electric field effect component Rg_em which arises from a skin effect and so forth.

Now, an output resistance is described.

In an actual device, a time delay of carriers arriving at the drain is caused by an NQS effect described above, and this gives rise to increase of the output resistance Rds. However, the compact model in related art fails to reproduce an NQS phenomenon on the output side (drain side) because the output resistance Rds illustrated in FIG. 3 is fixed independently of the frequency.

In a method in related art of correcting the deviation of the frequency characteristic caused by increase of the output resistance Rds, a simulation is performed and the substrate resistance value is fitted so that the output reflection coefficient S22 when the output side is terminated with a characteristic impedance may coincide with an ideal curve. Therefore, the labor in repeating a simulation and a change of parameters several times is required.

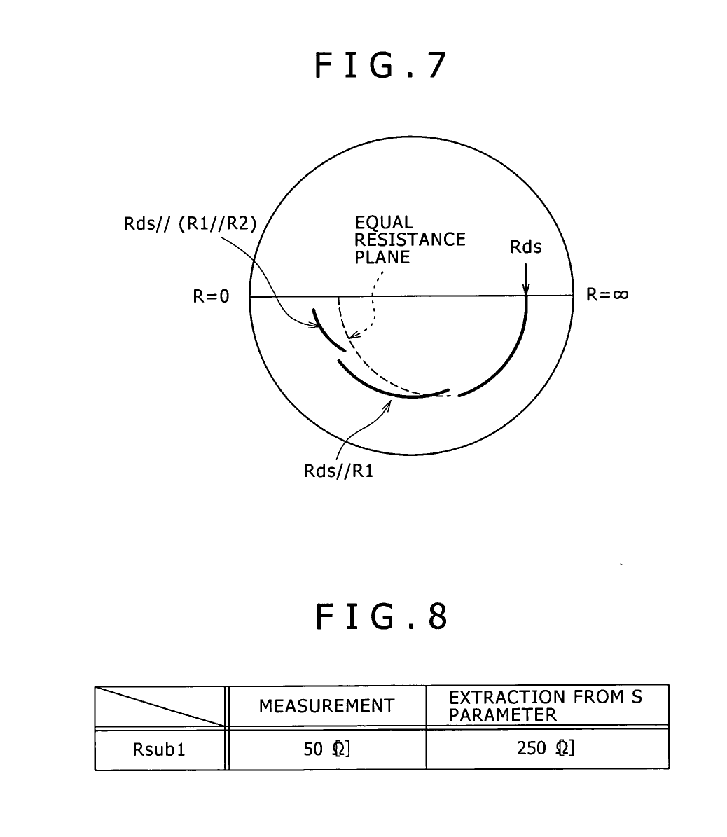

FIG. 6 illustrates extracted parameters necessary to suppress the influence of increase of the output resistance Rds in a high frequency through characteristic adjustment by the fitting in related art. FIG. 7 illustrates a locus of the output reflection coefficient S22 of the circuit shown in FIG. 6.

The circuit shown in FIG. 6 includes, as parameters which have an influence on the output reflection coefficient S22, the output resistance Rds in the intrinsic transistor section Mi connected between the drain terminal D and the source terminal S (having a potential equal to that of the back bias terminal B), and parameters of the substrate circuit portion (extrinsic circuit portion) connected in parallel to the output resistance Rds.

The substrate circuit portion includes a drain junction capacitance Cj_db and the substrate resistance Rsub1 connected in series between the drain terminal D and the source terminal S, and the substrate resistance Rsub2 and a source-substrate junction capacitance Cj_sb connected in series between a node between the drain-substrate junction capacitance Cj_db and the substrate resistance Rsub1 and the source terminal S.

Since the source resistance Rs and the drain resistance Rd shown in FIG. 1 are so low that they can be ignored when compared with the output resistance Rds, they are omitted in FIG. 6. Further, the substrate resistances Rsub3 and Rsub4 on the source side are omitted because the contribution thereof to the output reflection coefficient S22 is relatively low. Also the substrate capacitances Csub1 to Csub4 parallel to the substrate resistances are omitted for simplified illustration.

Where the output resistance Rds and the substrate circuit portion parallel to the output resistance Rds are represented by the configuration shown in FIG. 6, the output reflection coefficient S22 exhibits such a behavior on a Smith chart as shown in FIG. 7. In FIG. 7, since the output resistance Rds is fixed independently of the frequency, a manner can be seen wherein the impedance of the circuit shown in FIG. 6 deviates (decreases) from an equal resistance plane (ideal curve) in both of a case wherein the substrate resistance Rsub2 is taken into consideration and another case wherein the substrate resistance Rsub2 is not taken into consideration, that is, in both of the cases of “Rds//(Rsub1/Rsub2)” and “Rds//Rsub1”.

This is the reason why the actually measured values and the simulation values in FIG. 4D deviate from each other.

In order to correct the deviation, where the transistor model in related art is used, a method is taken wherein the substrate resistance value is fitted while the simulation result is referred to.

FIG. 8 illustrates a substrate resistance value (measured value) determined by calculation from a layout and a substrate resistance value extracted after fitting of the S parameter.

Referring to FIG. 8, the value 250 [Ω] of the drain substrate resistance Rsub1 extracted from the actually measured output reflection coefficient S22 is higher than the value 50 [Ω] of the drain substrate resistance Rsub1 determined by calculation from the layout. This can be explained that the effect of the NQS in a high frequency that the output resistance Rds increases is not reflected on the compact model because the output resistance Rds is fixed and therefore, if fitting of the S parameter is performed, then the substrate resistance Rsub increases so as to maintain the total power of the output reflection coefficient S22 thereby to lower the power consumption by the substrate side.

Therefore, the output resistance Rds in the intrinsic transistor section Mi is provided with a frequency dependency. As a method providing the output resistance Rds with a frequency dependency, the parameter (output resistance Rds) may be represented by a function of the frequency, or optimum values of the output resistance Rds for individual frequencies may be stored in advance as a table in a memory such that, if a frequency to be used is decided, then the optimum value of the output resistance Rds is read out in response to the frequency to automatically set the output resistance parameter.

All or some of the substrate resistances Rsub1 to Rsub4, for example, the substrate resistances Rsub1 and Rsub2, may be provided with a frequency dependency so that the influence of increase of the output resistance Rds is canceled in response to the frequency while the output resistance Rds is kept as a fixed value such as a default value. Also in this instance, as a method of providing a frequency dependency, the parameter (substrate resistance) may be represented by a function of the frequency, or optimum values of the substrate resistances for individual frequencies may be stored in advance as a table in a memory such that, if a frequency to be used is decided, then the optimum value of the substrate resistance is read out in response to the frequency to automatically set the substrate resistance parameter. Also the substrate capacitance may be provided with a frequency dependency by a method similar to that described above in addition to the substrate resistances.

It is to be noted that, where the substrate resistances are provided with a frequency dependency, preferably each of the substrate resistances Rsub1 to Rsub4 has a parameter structure though not illustrated in FIG. 1 in order to avoid complicated illustration. A layout component and a frequency dependent component (NQS component) are separate from each other. In particular, the drain substrate resistance Rsub1 is indicated by the sum of a layout component Rsub1_layout and an NQS component Rsub1_NQS; the substrate resistance Rsub2 by the sum of a layout component Rsub2_layout and an NQS component Rsub2_NQS; the substrate resistance Rsub3 by the sum of a layout component Rsub3_layout and an NQS component Rsub3_NQS; and the source substrate resistance Rsub4 by the sum of a layout component Rsub4_layout and an NQS component Rsub4_NQS. A particular example of the technique of separating the resistance components is hereinafter described.

In the present embodiment, an NQS phenomenon of the output side is reproduced by setting the parameter values of the output resistance Rds and/or the substrate resistances Rsub1 to Rsub4 of the extrinsic circuit as variable parameter values thereby to suppress a phenomenon in a frequency, that is, an influence of increase of the output resistance Rds (=1/gds) in a high frequency on the high-frequency characteristic.

Since the output resistance Rds and/or the substrate resistances Rsub1 to Rsub4 are provided with a frequency dependency as described above, optimum parameter values are obtained only by providing information of the used frequency without performing fitting of the parameters while a simulation result is referred to. As a result, measurement values of the S parameter of an actual device of the transistor model of the present embodiment particularly in terms of the input reflection coefficient S11, forward direction transmission coefficient S21, and output reflection coefficient S22, which depends principally upon the output resistance Rds, coincide well with actually measured values.

It is to be noted that the transistor model shown in FIG. 1 is an example of a preferable configuration.

As described hereinabove, the intrinsic transistor section Mi may be a compact model or an equivalent circuit model.

Here, the types and the combination of layout components to be included in the compact model are arbitrary. Accordingly, it is only necessary for a high-frequency transistor model to include at least one of such layout components as described hereinabove.

Such layout components as just mentioned include, in the high-frequency transistor model shown in FIG. 1, a layout component Rg_layout of the gate resistance, coupling capacitances Cc_gb and Cc_db between the wiring lines and the substrate, substrate resistances Rsub_gb and Rsub_db and substrate capacitances Csub_gb and Csub_db connecting to the coupling capacitances Cc_gb and Cc_db, a coupling capacitance Cc_gd between the wiring lines and a gate-source wiring line coupling capacitance Cc_gs, and inductances Lg_layout, Ls_layout, and Ld_layout of the wiring lines. Further, layout components which are not directly illustrated in FIG. 1 include layout components Rsub1_layout to Rsub4_layout of the substrate resistances Rsub1 to Rsub4 in the extrinsic circuit.

Further, where the source terminal S and the back bias terminal B are not short-circuited to each other, it is necessary to add, similarly as in the case of the drain side, a coupling capacitance between the source and the substrate, also a substrate resistance and a substrate capacitance, a coupling capacitance between the source wiring line and the drain wiring line, and so forth to the layout components.

It is to be noted that, since particularly the substrate resistances Rsub1 to Rsub4 and the substrate capacitances Csub1 to Csub4 from among the substrate resistances and the substances capacitances which form the substrate circuit of the extrinsic circuit differ depending upon the position of the location at which the back bias voltage is applied in addition to the original layout of the transistor, they may be included as layout parameters in the parasitic circuit.

The extrinsic circuit may have a configuration different from that shown in FIG. 1 depending upon the semiconductor device structure.

For example, in an SOI (Silicon-On-Insulator) transistor, the drain-substrate junction capacitance Cj_db and the source-substrate junction capacitance Cj_sb shown in FIG. 1 can be replaced by an insulation film capacitor of a box oxide film or the like. Generally, since the insulation film capacitance is considerably higher than a junction capacitance, it is possible to omit or simplify the substrate circuit formed from the substrate resistances Rsub1 to Rsub4 and the substrate capacitances Csub1 to Csub4. Although the semiconductor substrate is placed in an electrically floating state or is electrically fixed to a fixed voltage, usually the semiconductor substrate (back bias terminal B) is not connected to the source terminal S as seen in FIG. 1.

On the other hand, where the influence of the semiconductor substrate side can be ignored, it is possible to regard the substrate circuit shown in FIG. 1 as an equivalent circuit of an SOI body region. In this instance, the values of the substrate resistances and the substrate capacitances are much different from those of ordinary high-frequency transistors, and also the configuration of the substrate circuit differs depending upon the difference whether operation of the SOI type transistor is set to that of the partial depletion type or the full depletion type and the difference whether the body region is set to an electrically floating state or an electrically fixed state.

Furthermore, the two overlap coupling capacitances Cgs_ov and Cgd_ov shown in FIG. 1 may be included in the intrinsic transistor section Mi (for example, included in the capacitances Cgd_int and Cgs_int of the equivalent circuit model shown in FIG. 3) while they are omitted from the extrinsic circuit.

The high-frequency transistor model used in the present embodiment has the following advantages.

First, since the high-frequency transistor model used in the present embodiment has a parasitic circuit including parasitic components arising from the layout and parameters which vary to some degree depending upon the layout are incorporated in the transistor model from the beginning, the high-frequency transistor model is proximate to an actual device.

Second, since the high-frequency transistor model used in the present embodiment includes, in the gate resistance Rg0, the NQS gate resistance Rg_NQS which has an influence on time-delayed gate control of carriers traveling in the channel and includes, in the parasitic circuit, the electric field effect component Rg_em as a component having an influence on gate control of an electromagnetic field effect such as a skin effect so that a phenomenon in a high frequency can be reproduced, the high-frequency transistor model is proximate to an actual device with a high degree of accuracy.

Third, in the high-frequency transistor model used in the present embodiment, each of the substrate resistances Rsub1 to Rsub4 of the extrinsic circuit or an arbitrary necessary substrate resistance is represented as the sum of a component Rsub1_layout to Rsub4_layout determined from the layout and an NQS component Rsub1_NQS to Rsub4_NQS which has an influence on the time-delayed output resistance Rds of carriers traveling in the channel. Therefore, the output resistance Rds can be varied substantially in a similar manner to that of an actual device with respect to the frequency, and consequently, the high-frequency transistor model is proximate to an actual device with a high degree of accuracy.

Fourth, since each of the parameter representing the output resistance Rds in the intrinsic transistor section Mi and the substrate resistances Rsub1 to Rsub4 in the extrinsic circuit or at least one of arbitrary necessary substrate resistances has a frequency dependency, particularly the output reflection coefficient S22 has a frequency characteristic proximate to that of an actual device. Therefore, the high-frequency transistor model is proximate to an actual device with a high degree of accuracy.

As a synthetic advantage achieved by one of the first to fourth advantages described above or by a combination of some of the first to fourth advantages, according to the present embodiment, a layout-scalable high-frequency transistor model is implemented. In other words, the high-frequency transistor model used in the present embodiment can change the layout readily because it is not necessary to decide a parameter by the fitting technique, or even if this is necessary, the parameter can be optimized by a small amount of change.

<Example of a Production Method of the High-Frequency Transistor Model>

Now, an example of a production method of the high-frequency transistor model is described principally in connection with a method of deciding (extracting and settling) a parameter value.

A process of production of a high-frequency transistor is roughly divided into a step of producing, for example, the equivalent circuit shown in FIG. 1 to produce an outline of a model, and another step of deciding parameter values of the produced outline (equivalent circuit). Here, principally the step of deciding parameter values is described.

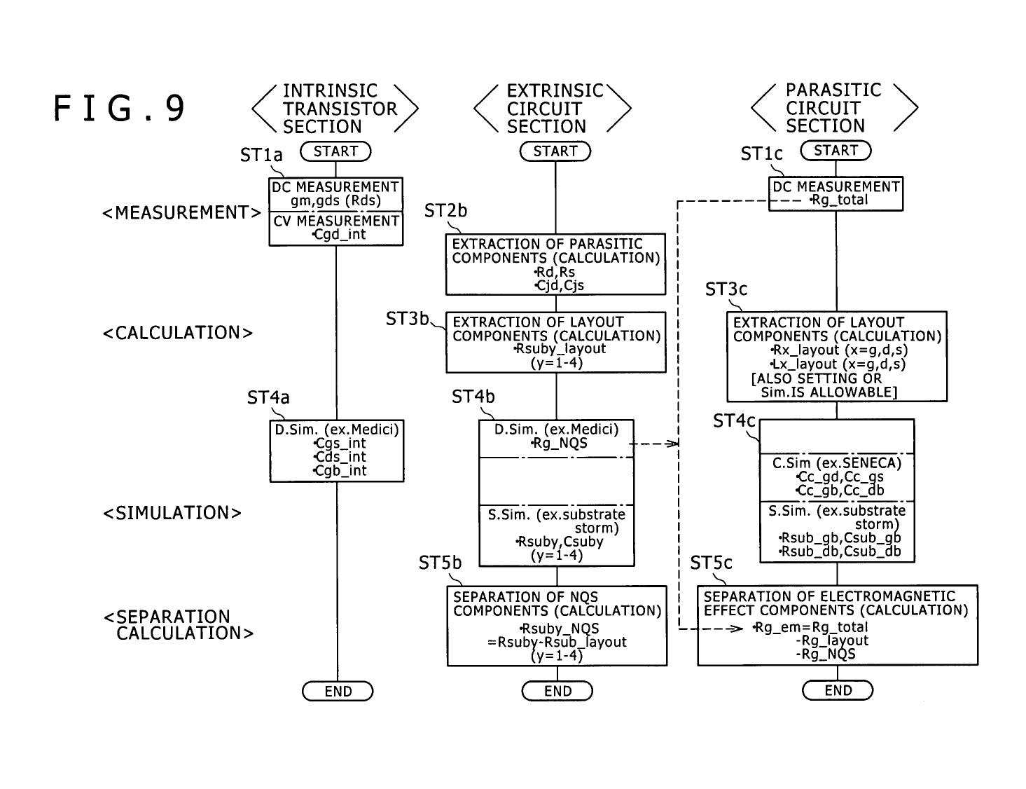

Principal steps for determining parameter values are illustrated in FIG. 9.

In FIG. 9, for the convenience of illustration, a parameter decision flow for the intrinsic transistor section, another parameter decision flow for the extrinsic transistor section, and a further parameter decision flow for the parasitic circuit are shown separately from each other. However, actual parameter decision is not limited to this, but it is efficient if parameters are decided for each type of operation such as, for example, measurement, calculation, and simulation. Further, the steps may be performed in an arbitrary order within a range within which the utilization relationship of the parameters does not exhibit any contradiction. In other words, the decision of parameter values to be used for calculation and so forth must naturally be performed prior to the calculation of the parameter values, and as far as this is observed, the steps may be performed in an arbitrary order.

Further, the particular parameter extraction method described here is a mere example at all, and the method is not restricted to this particular example. Further, also the types (trade names) of simulators, that is, “Medici” of a device simulator, “SENECA” of a capacitance simulator, and “substrate stream” or “3d Sim of DESISS” of a substrate simulator, are mere examples.

Referring to FIG. 9, for the intrinsic transistor section, measurement of the DC characteristic of a high-frequency transistor (for example, measurement of the current-voltage (I-V) characteristic) is performed at step ST1a to determine the mutual conductance gm and the drain conductance gds (that is, output resistance Rds).

Further, capacitance-voltage (C-V) measurement of the high-frequency transistor is performed to determine the intrinsic gate-drain capacitance Cgd_int.

At step ST4a, device simulation (D.Sim.) of the high-frequency transistor is performed at step STa4 to determine the intrinsic gate-source capacitance Cgs_int, intrinsic drain-source capacitance Cds_int, and intrinsic gate-substrate capacitance Cgb_int. Here, for example, “Medici” is used.

It is to be noted that, for the capacitances connected to the gate from among the parameters of the intrinsic transistor section, that is, for the intrinsic gate-drain capacitance Cgd_int, intrinsic gate-source capacitance Cgs_int, and intrinsic gate-substrate capacitance Cgb_int, command values (op values) prepared in advance in the compact model or the equivalent circuit model may be used alternatively.

Now, parameter decision with regard to the extrinsic circuit is described.

At step ST2b, calculation for extraction of parasitic components is performed to determine the drain resistance Rd, source resistance Rs, drain-substrate junction capacitance Cj_db, and source-substrate junction capacitance Cj_sb.

The drain resistance Rd and the source resistance Rs can be determined using the same calculation expression if the designs of the diffused layers (source region and drain region) of the source side and the drain side are symmetrical to each other. This calculation can be performed, if the drain resistance Rd is taken as an example, using the following expression (1):

$$RD = ( W / LD ) \cdot Rsheet\_d + ( W / Lext ) \cdot Rsheet\_ext + Rcon\_d / Ncon\_d \qquad ( 1 )$$

where “W” represents the width of the drain region and the extension portion of the drain region, “Ld” the effective length from the channel side end of the drain region to the contact, “Lext” the length of the extension portion, “Rsheet_d” the sheet resistance of the drain region, “Rsheet_ext” the sheet resistance of the extension portion, “Rcond_d” the contact resistance of one contact, and “Ncon_d” the number (integral number equal to or greater than 1) of contacts.

The drain-substrate junction capacitance Cj_db and the source junction capacitance Cj_sb can be determined using the same calculation expression if the designs of the diffused layers (source region and drain region) of the source side and the drain side are symmetrical to each other. This calculation can be performed, where the drain-substrate junction capacitance Cj_db is taken as an example, using the following expression (2):
Cj_{—}db=Sarea·Cunit_{—}area+Lperi·Cunit_{—}peri (2)
where “Sarea” represents the area of an area portion where the drain region is divided into the area portion and a peripheral portion (including an extension portion) around the area portion, “Lperi” the width of the peripheral portion, “Cunit_area” the junction capacity of the area portion per unit area, and “Cunit_peri” the junction capacitance of the peripheral portion per unit width.

At step STb3 shown in FIG. 9, calculation for extraction of layout components is performed to determine the layout components Rsuby_layout (y=1, 2, 3, and 4) of the substrate resistances. This calculation is performed using an effective in-substrate distance between the source region and the drain region, an effective in-substrate distance from the source region or the drain region to the back bias feeding point, and so forth together with the substrate sheet resistance. It is to be noted that it is otherwise possible to determine the layout components Rsuby_layout (y=1, 2, 3, and 4) of the substrate resistances from a result of a simulation (“Substrate strom” or “3D Sim. of DESISS).

At step ST4b, the device simulation (D.sim.) of the high-frequency transistor is performed to determine the NQS gate resistance Rg_NQS. Here, for example, “Medici” is used.

Further, substrate simulation (S.Sim.) is performed to determine the substrate resistances Rsuby and the substrate capacitances Csuby (y=1, 2, 3, and 4). Here, for example, “substrate stream” or “3D Sim. of DESISS” is used. It is to be noted that the substrate resistances Rsuby may alternatively be determined from the output reflection coefficient S22 of a measurement value.

At step STb5, calculation for separating NQS components from the substrate resistances is performed. The NQS components Rsuby-NQS (y=1, 2, 3, and 4) of the substrate resistances can be determined by subtracting the layout components Rsuby_layout from the substrate resistances Rsuby extracted from measurement values.

It is to be noted that, if the output resistance Rds in the intrinsic transistor is provided with a frequency dependency, then the steps ST5b and ST3b can be omitted.

Now, parameter decision with regard to the parasitic circuit is described.

At step ST1c, DC measurement of the high-frequency transistor is performed to determine the total gate resistance Rg_total of the high-frequency transistor. While, in the present example, the total gate resistance Rg_total is determined because it is required for calculation (step ST5c) for separation of an electromagnetic field effect component of the gate electrode hereinafter described, if the electromagnetic field effect component at step ST5c can be determined directly, for example, through a simulation, then the first step ST1c can be omitted.

At step ST3c, calculation for layout component extraction is performed to determine the layout component Rg_layout of the gate resistance, layout component Rd_layout of the drain resistance, and layout component Rs_layout of the source resistance.

The layout component Rg-layout differs depending on the provision of the gate contact. The layout component Rg_layout of the gate resistance can be performed by following expression (3) where, for example, the finger number of the gate electrode is M (M is an integral number equal to or greater than 1) and the gate wiring line is one layer.

$$Rg\_layout = k \cdot ( Lg / ( M \cdot Wfinger ) ) \cdot Rsheet\_gf + Rcon\_gf / Ncon\_gf + ( L 1 mg / W 1 mf ) \cdot Rsheet\_ 1 mg \qquad ( 3 )$$

where “k” represents the number of a value representative of a manner in which a contact is provided. For example, where a contact is to be provided on one side of the gate finger portion, k should be set to a value of ⅓, but where a contact is to be provided on both sides of the gate finger portion, k should be set to another value of 1/12. Further, “Lg” represents the effective length of the gate finger portion, “L1mg” the effective length of the gate wiring line, “Wfinger” the width of the gate finger portion, “W1mg” the effective width of the gate wiring line, “Rsheet_gf” the sheet resistance of the gate finger portion (gate electrode), “Rsheet_{—}1mg” the sheet resistance of the gate wiring line, “Rcon_gf” the contact resistance of the gate finger portion and one gate wiring line, and “Ncon_gf” the contact number (an integer equal to or greater than 1).

Also the layout component Rd_layout of the drain resistance and the layout component Rs_layout of the source resistance can be calculated in accordance with substantially similar expressions although the value of the coefficient k is different from that of the gate resistance.

Further, at the same step ST3c, the inductance component Lg_layout of the gate wiring line, the inductance component Ld_layout of the drain wiring line, and the inductance component Ls_layout of the source wiring line are determined. The parameters mentioned here may be calculated in this manner, may otherwise be fixed to respective unique values, or be determined through a simulation. In the present example, where an increasing amount of the inductor component of the gate wiring line in a high-frequency operation is included in the electric field effect component Rg_em determined at step ST5c hereinafter described, preferably the inductor component of the gate wiring line is fixed. It is to be noted that, though not described particularly, the manner in which the increasing amount of the inductor component of a wiring line in a high-frequency operation is reflected on a model can be applied also to the drain wiring line and the source wiring line.

At step ST4c, a capacitance simulation (C.Sim.) is performed to determine the gate-drain wiring line coupling capacitance Cc_gd, gate-source wiring line coupling capacitance Cc_gs, gate wiring line-substrate coupling capacitance Cc_gb, and drain wiring line-substrate coupling capacitance Cc_db. Here, for example, “SENECA” is used.

Further, a substrate simulation (S.Sim.) is performed to determine the gate coupling substrate resistance Rsub_gb, gate coupling substrate capacitance Csub_gb, drain coupling substrate resistance Rsub_db, and drain coupling substrate capacitance Csub_db. Here, for example, “substrate stream” is used.

At step ST5c, calculation for separating the electromagnetic field effect component from the total gate resistance is performed. The electric field effect component Rg_em of the gate resistance can be determined by subtracting, from the total gate resistance Rg_total, the layout component Rg_layout and the NQS gate resistance Rg_NQS of the total gate resistance Rg_total.

The parameter decision method illustrated in FIG. 9 is characterized in that it includes a step of extracting a layout component by calculation (for example, steps ST3b and ST3c) and preferably it additionally includes a step of separating a frequency dependent component, for example, an NQS component or an electromagnetic field effect component, by calculation using the layout component (for example, steps ST5b and ST5c). Since the parameters mentioned can all be determined by simple calculation, the present embodiment is advantageous in that the layout-scalable high-frequency transistor having the configuration example described hereinabove in connection with the first embodiment can be produced readily.

In FIG. 9, extraction of the substrate resistance Rsub is performed with regard to all of the four substrate resistances Rsub1 to Rsub4. However, one to three ones of the substrate resistances such as only the drain substrate resistance Rsub1 or the substrate resistances Rsub1 and Rsub2 may be extracted otherwise.

The values of the parameters decided in such a manner as described above are set to the parameters determined at the model outline production step thereby to complete production of a model which represents, when a transistor characteristic is to be determined in a desired high frequency, the high-frequency transistor with a high degree of accuracy on a computer.

It is to be noted that the model production method described above can be applied basically similarly to a high-frequency transistor formed on an SOI substrate. However, attention should be paid to the fact that no substrate circuit may exist or, even if a substrate circuit exists, the influence of the substrate is very little. Thus, the following method is preferable.

First, a device simulator is used to measure the output resistance Rds or the output reflection coefficient S22.

Then, an equivalent circuit for a signal transmitted to a semiconductor substrate through a box oxide film is constructed. This equivalent circuit is connected to the semiconductor substrate through the output resistance Rds and the box oxide film, and a device simulation is performed. The difference between a result of the simulation wherein the equivalent circuit is connected and a result of another device simulation wherein the equivalent circuit is not connected is calculated as an NQS component representative of a delay amount of charge. Preferably, the NQS component is provided with a frequency dependency. As a method of providing the NQS component with a frequency dependency, a function value which increases as the frequency increases may be provided or values corresponding to individual frequencies may be provided as a table.

Then, the other parameters are placed into the equivalent circuit to perform a circuit operation so that a transistor characteristic in a desired frequency is obtained. In this manner, a characteristic of a high-frequency SOI type transistor can be calculated from an equivalent circuit.

<Example of the Re-Production Method of a Model Upon Layout Change>

Now, a method of re-producing (updating) a model where the layout is changed after a high-frequency transistor model is produced by the method described above is described.

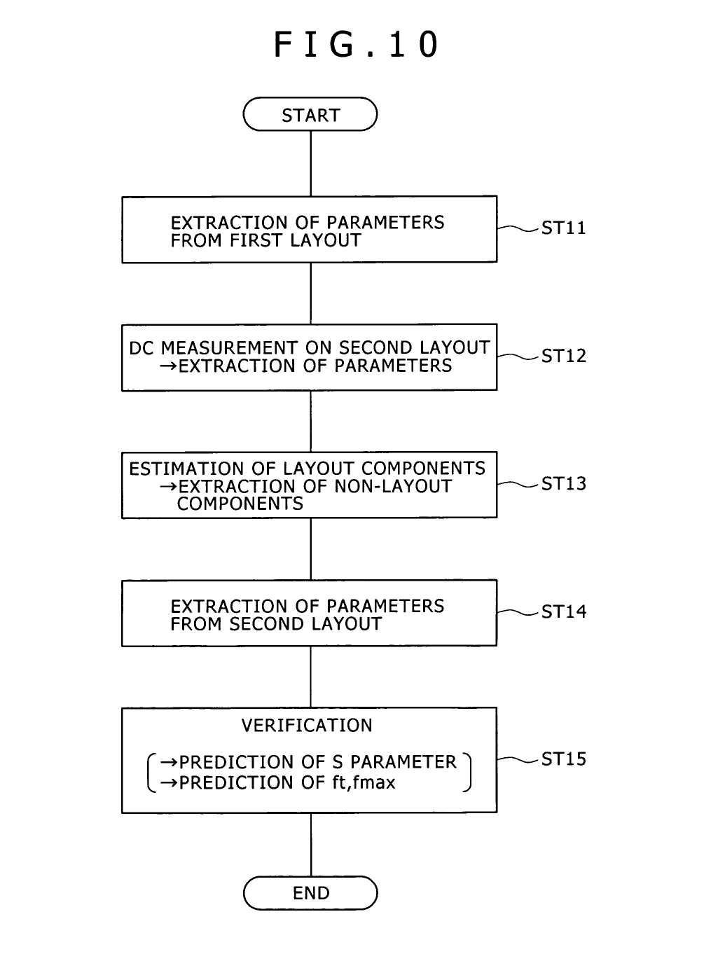

FIG. 10 illustrates an outline of the method of re-producing (updating) a model upon layout change.

Referring to FIG. 10, at step ST11, parameters are extracted from a first layout. For the extraction of the parameters, the method described hereinabove with reference to FIG. 9 can be used suitably. By the method, the values of the parameters of the intrinsic transistor section, extrinsic circuit, and parasitic circuit of the first layout are extracted or calculated.

At step ST12, the transistor characteristics of a high-frequency transistor of a second layout of an object of layout change when DC is applied are measured, and parameters are extracted from the transistor characteristics.

The transistor characteristics to be measured in DC at step ST12 include the mutual conductance gm, drain conductance gds (output resistance Rds), and so forth.

At step ST13, various resistances and various capacitances are estimated from the second layout.

The layout components which can be estimated from the second layout include the layout component Rg_layout of the gate resistance, layout component Cgs_layout of the gate-source capacitance, layout component Cgd_layout of the gate-drain capacitance, layout component Csb_layout of the source-substrate capacitance, layout component Cdb_layout of the drain-substrate capacitance, layout component Cgb_layout of the gate-substrate capacitance, and layout components Rsub1_layout to Rsub4_layout of the substrate resistances Rsub1 to Rsub4.

Although the layout component Cgs_layout of the gate-source capacitance, layout component Cgd_layout of the gate-drain capacitance, layout component Csb_layout of the source-substrate capacitance, layout component Cdb_layout of the drain-substrate capacitance, and layout component Cgb_layout of the gate-substrate capacitance are new parameters which are not used in the method according to the embodiment described above, they are layout components of the synthetic capacitances.

In particular, the layout component Cgs_layout of the gate-source capacitance is only a layout component extracted from a synthetic capacitance represented by the sum of the intrinsic gate-source capacitance Cgs_int, overlap coupling capacitance Cgs_ov of the gate and the source, and the gate-source wiring line coupling capacitance Cc_gs. Where it is premised that the material and the dimensions (thickness and width) of the source wiring line and laying of the wiring line are same in the first and second layouts, the layout component Cgs_layout of the gate-source capacitance can be estimated purely from the layouts.

This similarly applied also to any other layout component.

The layout component Cgd_layout of the gate-drain capacitance is only a layout component extracted from a synthetic capacitance represented by the sum of the intrinsic gate-drain capacitance Cgd_int and the gate-drain wiring line coupling capacitance Cc_gd.

The layout component Csb_layout of the source-substrate capacitance where the source terminal S and the back bias terminal B are not connected to each other is a layout component extracted from a synthetic capacitance represented by the sum of the source-substrate junction capacitance Cj_sb and part of the substance capacitance.

The layout component Cdb_layout of the drain-substrate capacitance is a layout component extracted from a synthetic capacitance represented by the sum of various capacitances, in particular, the drain-substrate junction capacitance Cj_db, part of the substrate capacitance, drain wiring line-substrate coupling capacitance Cc_db, and drain coupling substrate capacitance Csub_db.

Further, the layout component Cgb_layout of the gate-substrate capacitance is a layout component extracted from a synthetic capacitance represented by the sum of the intrinsic gate-substrate capacitance Cgb_int, gate wiring line-substrate coupling capacitance Cc_gb, and gate coupling substrate capacitance Csub_gb.

Now, estimation of the layout components where the high-frequency transistor is of the type having a multi-finger gate is described particularly.

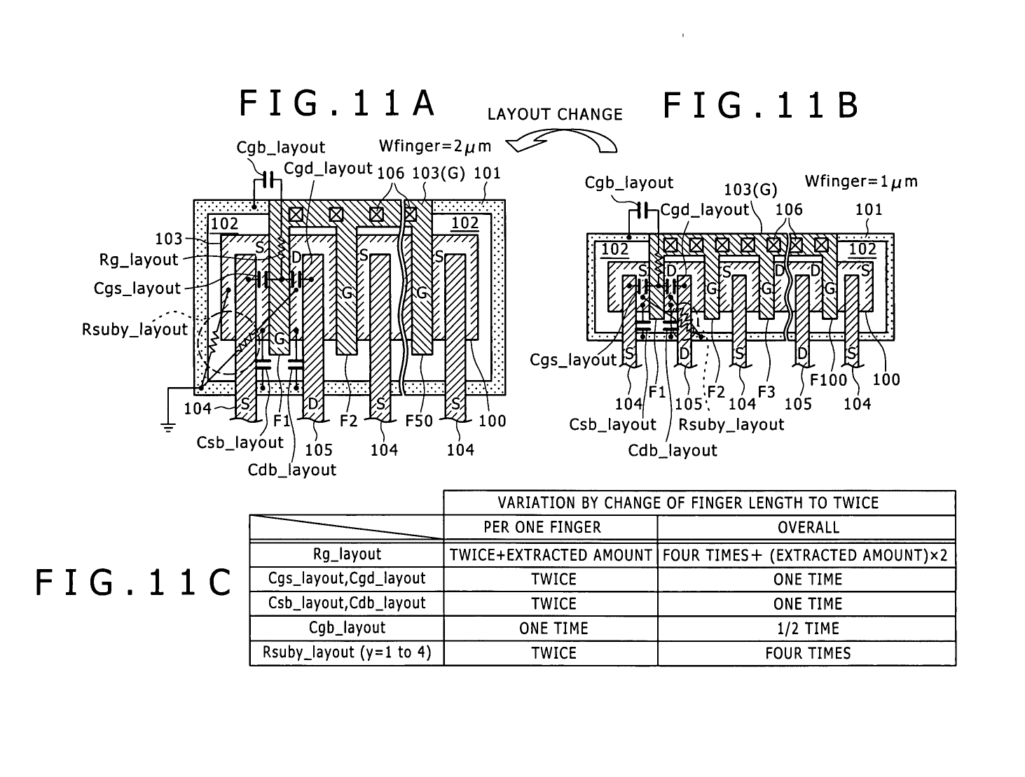

FIG. 11A is a plan view of a first layout and FIG. 11B is a plan view of a second layout, and FIG. 11C is a table illustrating magnifications of a parameter change upon layout change. In FIGS. 11A to 11C, a layout change wherein the gate finger length is extended to twice is illustrated.

First, a high-frequency transistor having a multi-finger gate is described briefly.

Referring to FIGS. 11A to 11C, in the transistor mentioned, an active region 100 of the transistor and a P-type impurity region (hereinafter referred to as substrate bias region) 101 for a substrate contact (for supplying a back bias) are formed on a P-type semiconductor substrate (or P well). The active region 100 and the substrate bias region 101 have geometrical shapes (patterns) by forming an element separating impurity layer 102 of a predetermined pattern on a surface portion of the semiconductor substrate.

A gate electrode layer 103 (denoted by “G” in FIGS. 11A and 11B) is formed, for example, from polycrystalline silicon and has finger portions F1, F2 . . . extending across the active region 100. Since the finger portions F1, F2 . . . extend perpendicularly to the active region 100, the width of the active region 100 defines an effective gate length (gate width of the transistor) Wfinger of the gate finger portion. This dimension Wfinger is hereinafter referred to as “finger length”. The finger length Wfinger in the first layout of the present example is 1 μm and the finger length Wfinger in the second layout is 2 μm. It is necessary to make the total effective gate width of the transistor equal before and after the layout change, and from this, where the number of finger portions in the first layout is 100, then the number of fingers in the second layout is 50 and hence is reduced to one half.

An N-type impurity is introduced into the active region 100 by ion implantation using the gate electrode layer 103 as a mask. Consequently, N-type source regions SR and drain regions DR are formed alternately in the longitudinal direction of the active region 100.

A source wiring line layer 104 made of first metal is connected to the source regions SR while a drain wiring line layer 105 made of the first metal is connected to the drain regions DR. While the source wiring line layer 104 and the drain wiring line layer 105 are led out in the same direction in FIGS. 11A and 11B, they may otherwise be led out alternately in the opposite directions.

On the other hand, a predetermined number of gate contacts 106 for connecting the gate electrode layer 103 to upper layer metal are provided on the gate electrode layer 103. Particularly where the source wiring line layer 104 and the drain wiring line layer 105 are led out in different directions from each other, the gate electrode layer 103 is connected to a gate wiring line layer (not shown) of second metal through the gate contacts 106.

Referring to FIGS. 11A and 11B, layout components which can be estimated from the layouts include the layout component Rg_layout of the gate resistance, layout component Cgs_layout of the gate-source capacitance, layout component Cgd-layout of the gate-drain capacitance, layout component Csb_layout of the source-substrate capacitance, layout component Cdb_layout of the drain-substrate capacitance, layout component Cgb_layout of the gate-substrate capacitance, and layout components Rsub1_layout to Rsub4_layout (denoted by Rsuby-layout [y=1, 2, 3, and 4] in FIGS. 11A and 11B) of the substrate resistances Rsub1 to Rsub4.

The significance of the parameters is described hereinabove and therefore is not repeated here. Here, it is examined in what manner the parameters vary when the finger length Wfinger is changed to double.

As regards the layout component Rg_layout of the gate resistance, since, when the finger length is doubled, the polycrystalline silicon resistance per one finger is doubled and the number of contacts per unit resistance decreases, this is added as an (extracted amount). Since the number of fingers decreases to one half as a whole, it is necessary to further double the variation magnification per one finger. Accordingly, the layout component Rg_layout of the gate resistance is given, after the layout change, as [four times+(extracted amount)×2] which is that prior to the layout change.

As regards the layout component Rsuby_layout of the substrate resistance, if the finger length increases to twice, then it is considered that also the average distance from the source region SR or the drain region DR to the substrate bias region 101 increases substantially to twice. Therefore, the layout component Rsuby_layout of the substrate resistance increases to twice per one finger and to four times as a whole by the layout change.

In this manner, if the number of fingers decreases to one half, then the resistance increases to twice in this manner, but in contrast, as regards the capacitance, as the number of fingers decreases to one half, also the capacitance decreases to one half.

In particular, the layout component Cgs_layout of the gate-source capacitance, layout component Cgd_layout of the gate-drain capacitance, layout component Csb_layout of the source-substrate capacitance, and layout component Cdb_layout of the drain-substrate capacitance are increased to twice and to one time as a whole by the layout change. Meanwhile, the layout component Cgb_layout of the gate-substrate capacitance changes to one time per one finger and to ½ time as a whole by the layout change.

At step ST13, components which have no layout dependency or have an ignorably low layout dependency such as, for example, an NQS component and an electromagnetic field effect component and, for example, components having a frequency dependency higher than the layout dependency are extracted from the first layout. A component which has no or little layout dependency or has a layout dependency to which no importance is attached is hereinafter referred to as 37 non-layout dependent component”.

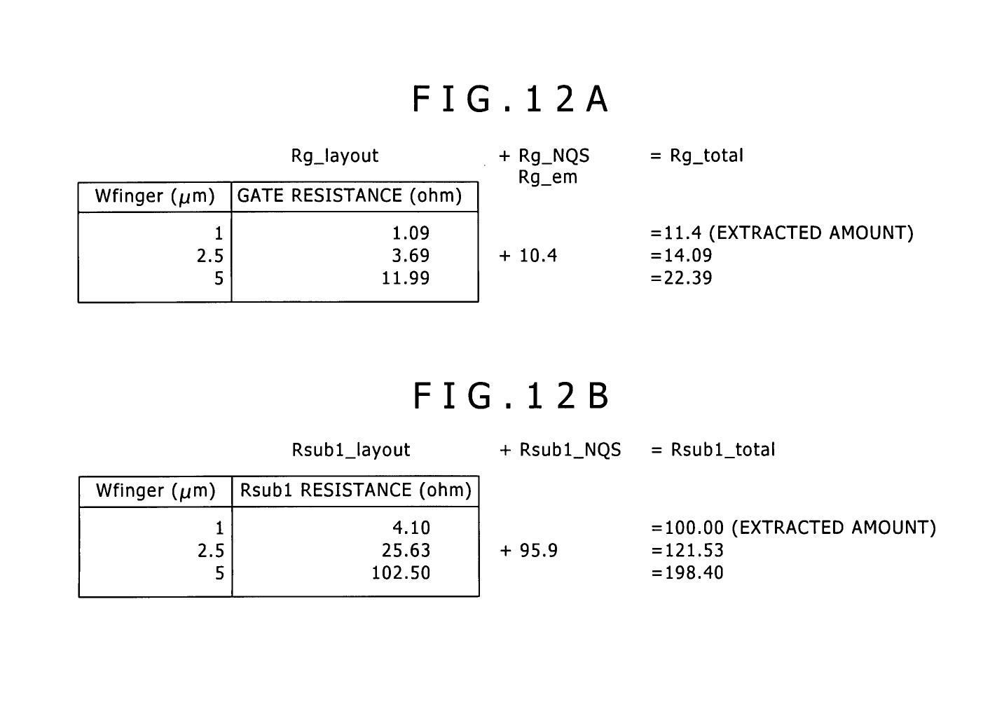

FIGS. 12A and 12B illustrate a particular extraction method of a non-layout dependent component using the gate resistance Rg and the substrate resistance Rsub1 as an example.

Here, it is presupposed that any non-layout dependent component does not rely upon the layout at all. However, if it is found that the non-layout dependent component relies a little on the layout, then it is possible to multiply the determined non-layout dependent component by a correction coefficient around “1” determined empirically.

Referring to FIG. 12A, when the finger length Wfinger is varied from 1 μm (first layout) to 2.5 μm and 5 μm (second layout), the layout component Rg_layout of the gate resistance changes from 1.09 Ω to 3.69 Ω and 11.99 Ω, respectively. The total gate resistance Rg_total regarding the first layout has been determined already at step ST11 described hereinabove, and if it is assumed that the value of the determined total gate resistance Rg_total is 11.4 Ω, then the non-layout dependent component of the total gate resistance Rg_total, that is, the sum of the NQS gate resistance Rg_NQS and the electric field effect component Rg_em, can be calculated as 10.4 Ω. Since this value is a fixed value and does not rely upon the layout, it can be applied also to the second layout. Then, the total gate resistance Rg_total when the finger length Wfinger is 2.5 μm can be calculated as 14.09 Ω, and the total gate resistance Rg_total when the finger length Wfinger is 5 μm can be calculated as 22.39 Ω.

Referring to FIG. 12B, when the finger length Wfinger is varied from 1 μm (first layout) to 2.5 μm and 5 μm (second layout), the layout component Rsub1_layout of the substrate resistance changes from 4.10 Ω to 25.63 Ω and 102.50 Ω, respectively. The total substrate resistance Rsub1_layout regarding the first layout has been determined already at step ST11 described hereinabove, and if it is assumed that the value of the determined total substrate resistance Rsub1_layout is 100.00 Ω, then the non-layout dependent component of the total substrate resistance Rsub1_layout, that is, the NQS component Rsub1_NQS, can be calculated as 95.9 Ω. Since this value is a fixed value and does not rely upon the layout, it can be applied also to the second layout. Then, the total substrate resistance Rsub1_layout when the finger length Wfinger is 2.5 μm can be calculated as 121.53 Ω, and the total substrate resistance Rsub1_layout when the finger length Wfinger is 5 μm can be calculated as 198.40 Ω.

At step ST14 illustrated in FIG. 10, the parameters extracted by the method described above are set, and items of the parameters and the remaining parameters are decided.

More particularly, for the intrinsic gate-substrate capacitance Cgb_int, intrinsic gate-drain capacitance Cgd_int, and intrinsic gate-source capacitance Cgs_int, in the case of the compact model, for example, command values (op values) of the BSIM3 ver. 3 are used. Further, assuming that the layout pattern of the finger gate is changed but layout change of any other wiring line is not performed, the inductance component Ld_layout of the drain wiring line and the inductance component Lg_layout of the gate wiring line each including the pad inductance are set to a fixed value, for example, to 34 pH while the inductance component Ls_layout of the source wiring line including the pad inductance is set to another fixed value, for example, to 0.003 pH.

Other parameters which are estimated to change upon the layout change are calculated or, if necessary, re-extracted by a device simulator. For example, while the inclination of the Id-Vd characteristic is very important with an analog circuit, since the value thereof should be changed when the finger length Wfinger is changed, those parameters which participate in the inclination are changed in response to the finger length.

After all necessary parameters are set, it is verified at next step ST15 whether or not the set parameter values are appropriate by performing circuit operation (device simulation) using the parameter values or measuring frequency characteristics (S parameter, current gain cutoff frequency ft and maximum operation frequency fmax). This makes it possible to predict a high-frequency characteristic.

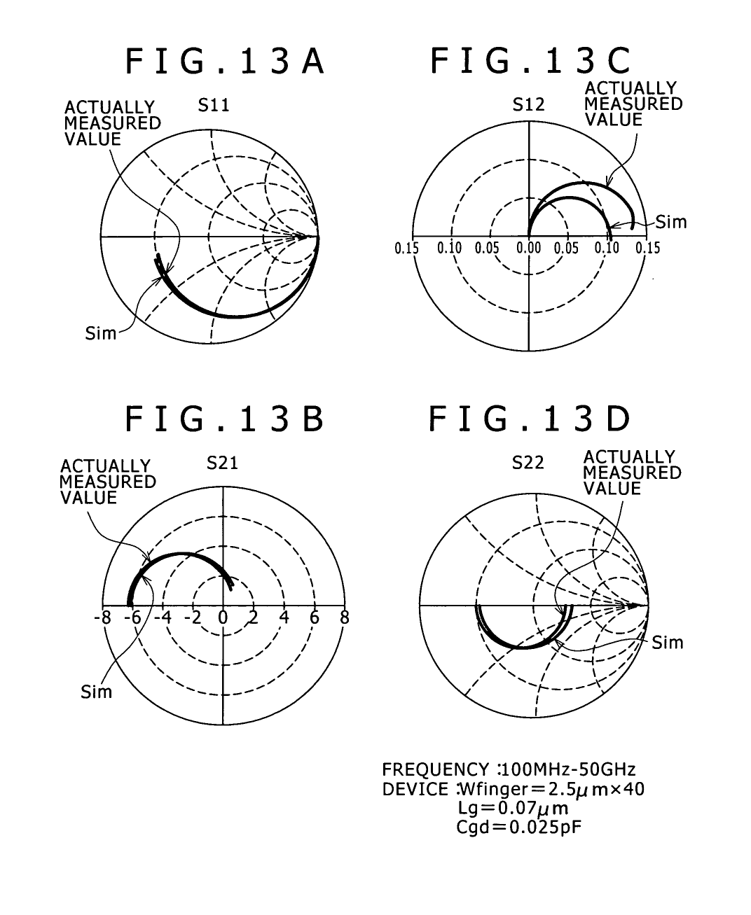

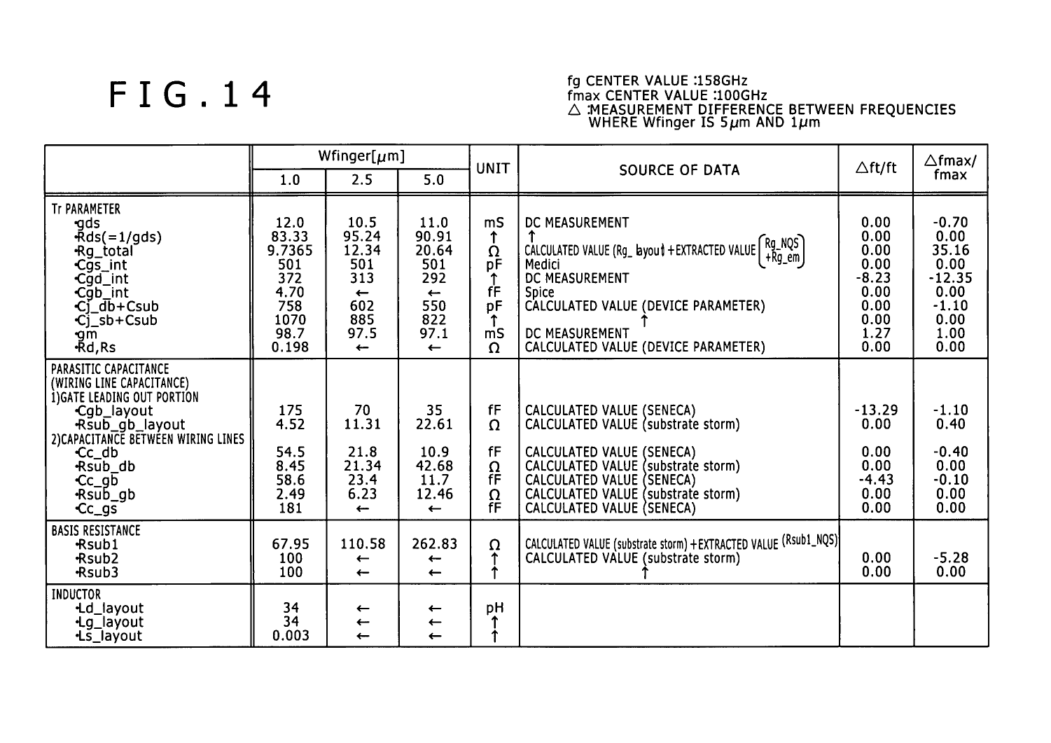

FIGS. 13A to 13D are Smith charts representative of comparison between S parameters calculated by the method described above and actually measured data. FIGS. 13A to 13D indicate measured values (actually measured values) of the S parameter of an actual device and a simulation result (“Sim.”) after parameter setting with the transistor model of the present embodiment. In the high-frequency transistor having a multi-finger gate, the finger length Wfinger of each finger gate is 2.5 μm; the number of the fingers is 40; the width (gate length) Lg of each gate finger portion is 0.07 μm; and the gate-drain capacitance (actually measured value) is 0.025 pF. Further, the measurement frequency is changed from 100 MHz to 50 GHz.

From FIGS. 13A to 13D, it can be seen that the calculated S parameter values and the actually measure data coincide well with each other, and it is understood that the method described above is reasonable. It can be confirmed that, where the method described above is used, a scalable high-frequency transistor model relating to the finger length Wfinger is constructed.

According to the model re-production method described above, since layout dependent components are definite, if a high-frequency transistor model of a certain layout is produced once, then when the layout is to be changed later, it is apparent what parameters of the high-frequency transistor model should be changed to what degrees. Therefore, the advantages that the labor required for model re-production (change) involved in the layout change is minimized and that reduction of the cost with regard to the man and the time and effective utilization of hardware resources can be anticipated are achieved.

<Example of an Optimization Technique for Parameters>

Now, an example of a technique for optimizing parameters of a high-frequency transistor is described.

In the optimization technique, sensitivity analysis of specifying parameters which contribute to maintenance and improvement of high-frequency characteristics is performed, and those parameters which should be optimized are determined from a result of the optimization analysis.

FIG. 14 is a table illustrating results of the sensitivity analysis.

Here, the sensitivity analysis was conducted with regard to 23 parameters illustrated in FIG. 14. Those parameters which are not described hereinabove are a capacitance Cgb_layout between the substrate and the gate lead portion principally including a gate electrode portion other than the gate finger portion and an in-substrate resistance Rsub_gb_layout connected in series to the capacitance Cgb_layout. Here, the capacitance Cgb_layout is calculated using the capacitance simulator “SENECA” while the in-substrate resistance Rsub_gb_layout is calculated using the substrate simulator “substrate storm”. Since the other parameters are described hereinabove, overlapping description of them is omitted here to avoid redundancy.

The sensitive analysis was conducted with regard to the 23 parameters in three patterns wherein the finger length Wfinger is 1.0 μm, 2.5 μm, and 5.0 μm. Further, in the sensitivity analysis, as an index to what degree the frequency difference appears in each of the current gain cutoff frequency ft and the maximum operation frequency fmax where the finger length Wfinger is 1.0 μm and 5.0 μm, a value obtained by normalizing the frequency difference with a center value was used.

As a result, it was found that the parameters having a significant influence on the current gain cutoff frequency ft by a layout change are, in the descending order of the degree of the influence, the capacitance Cgb_layout between the gate lead portion and the substrate, intrinsic gate-drain capacitance Cgd_int, and gate wiring line-substrate coupling capacitance Cc_gb. Meanwhile, the parameters having a significant influence on the maximum operation frequency fmax are, in the descending order of the degree of the influence, the total gate resistance Rg_total, intrinsic gate-drain capacitance Cgd_int, and substrate resistance Rsub1.

It is to be noted that the high-frequency characteristics with regard to which sensitivity analysis of a parameter is performed may include the S parameter in addition to those described above.

According to the parameter optimization method described above, it can be recognized readily from a result of the sensitivity analysis of parameters to a high-frequency characteristic in what manner the layout should be improved based on principal parameters which have an influence on a high-frequency characteristic such as, for example, the current gain cutoff frequency ft and the maximum operation frequency fmax. As a result, points of the layout to be improved can be forecast in advance, and the advantages that the labor required for the layout change is minimized and that reduction of the cost with regard to the man and the time and effective utilization of hardware resources can be anticipated are achieved.

It has been referred to in the description above that some of parameters are provided with a frequency dependency. In addition, a bias dependency can be provided to several principal parameters. A method for this is described below.

Generally, in an existing compact model, since the capacitance components (capacitance parameters) are not appropriate, an error appears if the compact model operates in all biases (bias voltages or bias currents). Here, the error component is determined for every bias.

More particularly, a high-frequency transistor model to which an extracted parameter is set is operated with a certain bias, for example, by a device simulator or the like, and a parameter value obtained then and a parameter value of a compact model are compared with each other to determine the difference therebetween. This operation is executed with all biases (more realistically, with discrete representative points) for each of all or necessary parameters. This difference or the correct parameter value is stored for each bias, for example, as a table. When an actual high-frequency transistor model is operated by a simulator or the like, the differences between parameter values or the correct parameter values are read out in response to a bias to be used for the required operation, and the values of the parameters are automatically corrected with the read out parameter values. It is to be noted that, where the differences are used, they are added to the existing parameter values of the compact model. On the other hand, where the correct parameter values are used, the existing parameter values of the compact model are set to zero and in fact replaced with the correct parameter values.

As a representative one of those parameters which make a factor of an error if they do not have such a bias dependency as described above, the intrinsic gate-drain capacitance Cgd_int and the intrinsic gate-source capacitance Cgs_int can be listed. Further, if necessary, it is possible to provide a bias dependency to any other parameter.

Where a bias dependency is provided to necessary parameters in this manner, a high-frequency transistor model to be incorporated in a simulator which uses a compact model (BSIM3 ver. 3, MOS model 9, EKV) which operates with all biases can operate further appropriately thereby to make a simulation of a high degree of accuracy possible. Here, if the high-frequency transistor model is utilized, then the type of the simulator and the type of the compact model are arbitrary.

While the power consumption is not referred to in the foregoing description, where a CR series circuit is formed from a substrate coupling capacitance and a substrate resistance, preferably the parameters are set so that the CR series circuit may operate in a region of the power consumption which is lower than a peak point of the power consumption.

More particularly, a CR series circuit is formed from the gate wiring line-substrate coupling capacitance Cc_gb and the gate coupling substrate resistance Rsub_gb shown n FIG. 1, and another CR series circuit is formed from the drain wiring line-substrate coupling capacitance Cc_db and the drain coupling substrate resistance Rsub_db. The CR series circuits have a peak of power consumption, and the substrate resistance at the peak can be calculated by ½nC. Here, C is the value of the gate wiring line-substrate coupling capacitance Cc_gb or the drain wiring line-substrate coupling capacitance Cc_db. In order to suppress the power consumption by the substrate in the embodiment, although there is a restriction to the wiring line structure and the substrate resistance, preferably the value of the gate wiring line-substrate coupling capacitance Cc_gb or the drain wiring line-substrate coupling capacitance Cc_db is set so that the substrate resistance may be displaced by an amount as great as possible from the peak point within the range of the restriction or the power consumption may be reduced sufficiently.

By the parameter optimization technique described above, prediction of a characteristic can be achieved readily in addition to the advantage that the accuracy in simulation enhances as described hereinabove in connection with the embodiment. In short, since it is impossible in related art to find an influence of a parameter of a transistor model on a characteristic, a prototype in related art is produced (a device is produced actually) and characteristics of the prototype are measured, and then a result of the measurement is fitted with desired characteristics to determine correct parameters. In contrast, if the optimization of parameters described above is performed, then an influence of each parameter on the high-frequency characteristics can be found to some degree. Therefore, the parameter optimization technique is advantageous in that characteristics of a transistor unit of a high-frequency circuit can be predicted without producing a prototype as in the prior art. Further, a factor for optimizing a characteristic to be determined is clarified and also optimization of the layout is facilitated.

<Example of the Structure and the Designing Method of a High-Frequency Transistor>

A structure and a designing method of a high-frequency transistor according to the present invention based on the assumption described above are described below taking a case wherein the layer of a wiring line is changed as an example.

First, a layout and a sectional structure before the change are described.

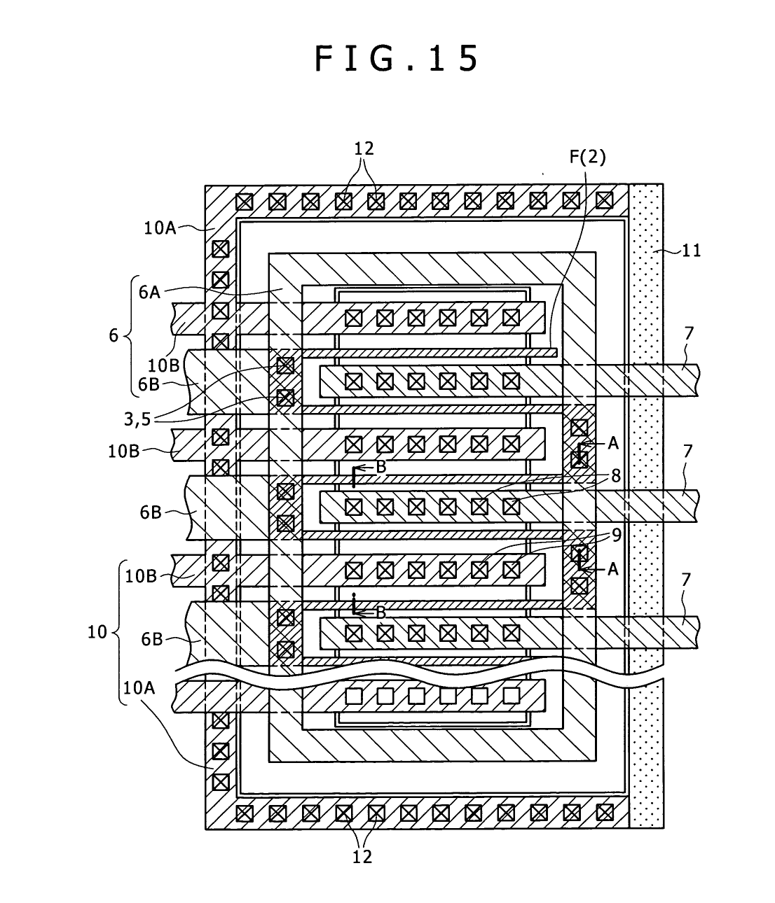

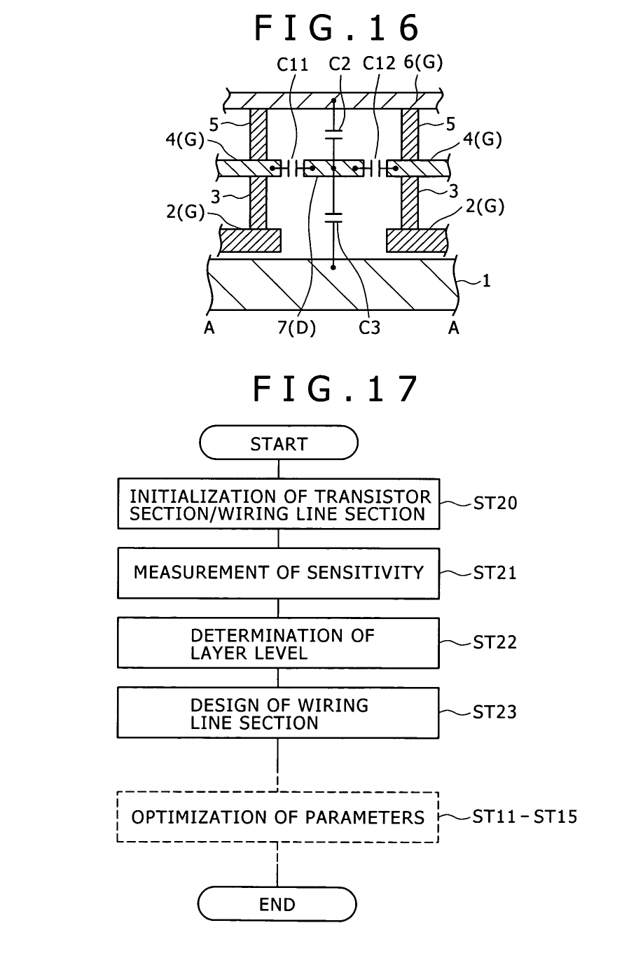

FIG. 15 shows a plan view of a high-frequency transistor having multi-fingers prior to the change, and FIG. 16 shows a schematic cross section taken along line A-A of FIG. 15. It is to be noted that, in the sectional view shown in FIG. 16, any portion which is made of an insulating material is omitted for the simplified illustration.

An active region 1A having a rectangular pattern is formed as seen in FIG. 15. A gate electrode 2 is formed as a gate G of the high-frequency transistor such that finger portions F extend transversely across the active region 1A. The finger portions F are formed on a thin gate insulating film (not shown) formed by thermal oxidation of the active region 1A. The gate electrode 2 is made of, for example, polycrystalline silicon and formed like a single line in a planar pattern from a plurality of finger portions F disposed substantially in parallel to each other and a plurality of connecting portions of an increased width each interconnecting two adjacent ones of the finger portions F.

FIG. 16 shows a section centered at a portion between two such connecting portions. A first gate contact 3 is formed on the connection portion of the gate electrode 2, and an intermediate connection layer 4 having a plane pattern substantially same as that of the connecting portion is formed from first layer metal (1MT) on the first gate contact 3. Further, the intermediate connection layer 4 is connected to a gate wiring line 6 formed from second layer metal (2MT) through a second gate contact 5. As shown in FIG. 15, the gate wiring line 6 has a portion 6A in the form of a rectangular framework greater than the active region 1A, and a plurality of thick wiring line portions 6B extending in one direction from the portion 6A. Though not shown, the thick wiring line portions 6B are connected commonly to the external gate terminal G0 (refer to FIG. 1) of the transistor unit.

Referring to FIG. 16, a drain wiring line 7 formed from the 2MT similarly to the intermediate connection layer 4 of the gate electrode extends between adjacent ones of the gate portions G of the intermediate connection layer 4 of the gate electrode. Thus, a plurality of drain wiring lines 7 are formed as seen in FIG. 15, and each of the drain wiring lines 7 is connected to a drain region (impurity diffusion layer) 9 formed in the active region 1A through several drain contacts 8. It is to be noted that the drain region and the drain contacts 8 do not appear in FIG. 16. The drain wiring lines 7 extend to the opposite side to the thick wiring line portions 6B of the gate electrode and are connected commonly to the external drain terminal D0 (refer to FIG. 1) of the transistor unit.

Though not shown in the sectional view of FIG. 16, the drain contacts 8 are formed form the 2MT same as that of the drain wiring line 7. Referring to FIG. 15, a source wiring line 10 has a substrate contact portion 10A extending on the outer side of the gate wiring line 6, and a wiring line portion 10B extending from the substrate contact portion 10A in the same direction as the thick wiring line portions 6B of the gate wiring line. The substrate contact portion 10A of the source wiring line extends above a substrate contact region 11 formed along the periphery of the element separating insulating layer 2, and the substrate contact portion 10A and the substrate contact region 11 are connected to each other by a large number of source-substrate contacts 12.

In the high-frequency transistor having such a wiring line section as described above, as seen from FIG. 16, the gate-drain wiring line coupling capacitance Cc_gd (refer to FIG. 1) which has a significant influence on the high-frequency characteristic as a layout component depends principally upon a synthetic value of the values C11, C12, and C2 of the three coupling capacitances. The values C11 and C12 of the coupling capacitances are capacitance values between those of the drain wiring lines 7 which are adjacent each other in the 1MT of the same layer and the intermediate connection layer 4 of the gate electrode. Meanwhile, the value C2 of the coupling coefficient is a capacitance value between the drain electrode 7 made of the 1MT and the gate wiring line 6 (strictly the portion 6A) positioned in the upper layer with respect to the drain wiring line 7 and made of the 2MT. In the structure of the wiring line section shown in FIG. 16, the drain wiring line is surrounded by the gate wiring line and the gate contact, and as a result, the gate-drain wiring line coupling capacitance Cc_gd is likely to become high. Where it is desired to make the gate-drain wiring line coupling capacitance Cc_gd low, since it is necessary to increase the distance between adjacent wiring lines or between a wiring line and a contact, this is contradictory to the requirement for reduction of the transistor occupation area.

On the other hand, the drain wiring line-substrate coupling capacitance Cc_db (refer to FIG. 1) as a different layout component depends upon the value C3 of the coupling capacitance shown in FIG. 16. The coupling capacitance value C3 is comparatively high because the drain wiring line 7 is made of the 1MT, and it is difficult to lower the coupling capacitance value C3.

Now, an example of a designing method of a high-frequency transistor having such a configuration as described above is described.

Here, description is given of a case wherein the configuration shown in FIGS. 15 and 16 is determined as a first layout and sensitivity measurement is performed with regard to the coupling capacity principally between wiring lines or between a wiring line and the substrate from among the equivalent circuit parameters of the first layout, and then the design of the first layout is changed to a new second layout from a result of the sensitivity measurement.

FIG. 17 illustrates different steps of the method of designing a high-frequency transistor.

Referring to FIG. 17, at step ST20, the transistor section is designed (transistor section designing step), and the wiring line section for the transistor section is designed. Consequently, the design of the first layout is completed already.

Then at step ST21, sensitivity measurement of the high-frequency transistor of the first layout is performed. More particularly, the sensitivity to a high-frequency characteristic of the high-frequency transistor is measured with regard to the coupling capacitances between the wiring lines including the gate wiring line 6, source wiring line 10, and drain wiring line 7 and the coupling capacitances between the wiring lines and the semiconductor substrate 1 from among the equivalent circuit parameters which vary in response to the configuration of the wiring lines and the contacts (configuration of the wiring line section).

The coupling capacitances between wiring lines which make an object of the measurement include the gate-drain wiring line coupling capacitance Cc_gd and the gate-source wiring line coupling capacitance Cc_gs (refer to FIG. 1), and the drain-source wiring line coupling capacitance Cc_ds which is not shown in FIG. 1.

The coupling capacities between the wiring lines which make an object of the measurement and the semiconductor substrate include the drain wiring line-substrate coupling capacitance Cc_db and the gate wiring line-substrate coupling capacitance Cc_gb (refer to FIG. 1). Further, where the source terminal S and the back bias terminal B are not connected to each other, the source wiring line-substrate coupling capacitance Cc_sb is selected as an object of the measurement.

The measurement of the sensitivity can be performed, for example, by a method similar to the method described in the <Example of an Optimization Technique for Parameters>. In the <Example of an Optimization Technique for Parameters>, the value of the finger length Wfinger is changed to perform the sensitivity measurement. Here, however, the value of each of the coupling capacitances mentioned above is successively changed to perform the sensitivity measurement. In this instance, the high-frequency characteristic with regard to which the influence of the coupling capacitance value is to be estimated can be set to the current gain cutoff frequency ft or the maximum operation frequency fmax similarly to the example described hereinabove.

By the sensitivity measurement, the preferential order of the coupling capacitances to be changed is determined in the descending order of the magnitude of the influence on the high-frequency characteristic.

At step ST22, the layered level of each wiring line is determined based on the preferential order (level decision step).

Then at next step ST23, the wiring line section is designed while the determined layered levels are observed (wiring line section designing step). For example, patterns of the gate wiring line, source wiring line, and drain wiring line in each of the determined layered levels and the arrangement and the size of each of the contacts between the wiring lines or each of the contacts between the wiring lines and the transistor section are designed. Further, the layered levels of the wiring lines may be changed without changing the layered relationship between the wiring lines.

Thereafter, re-production of a model may be performed in a similar manner as in the method described hereinabove with reference to FIG. 10. If the parameters to be changed are found based on a result of the verification in this instance, then such changes of the parameters are preferably fed back to the designing step ST20 for the transistor section and the wiring lines.

Further, as described in the item of the <Example of the Structure and the Designing Method of a High-Frequency Transistor>, where the power consumption of an RC series circuit of the semiconductor substrate exhibits a maximum value using a substrate simulator or the like, preferably the device parameters such as the substrate resistance or the parameters of the wiring line section are changed so that the power consumption may be lower than the maximum value. Also in this instance, the layered levels of the wiring lines may be changed without changing the layered relationship between the wiring lines. After the change, verification is performed further to confirm that the power consumption of the RC series circuit of the semiconductor substrate is lower than the maximum value.

In the following, several forms (structure examples) of the high-frequency transistor according to the present invention obtained as a result of a layout change where reduction of the coupling capacitance regarding the drain wiring line takes precedence most are described.

### STRUCTURE EXAMPLE 1

In the method of designing a high-frequency transistor according to the present embodiment, in order to reduce the coupling capacitance between the drain wiring line and the gate wiring line and the coupling capacitance between the drain wiring line and the substrate without changing the transistor size, preferably the drain wiring line is formed in an upper layer with respect to the gate wiring line (structure example 1).

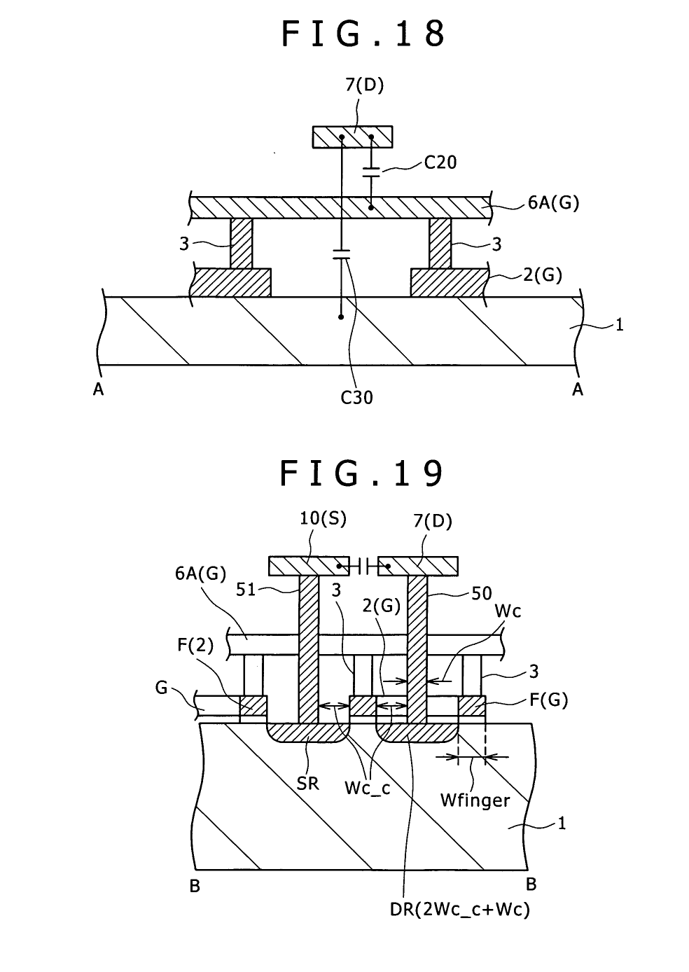

FIG. 18 is a sectional view of the structure example 1. In this instance, the plane pattern itself can be designed similarly as in FIG. 15. In particular, in FIG. 18, the portion 6A in the form of a rectangular framework of the gate wiring line is formed from the 1MT, and the intermediate connection layer 4 and the second gate contact 5 (FIG. 16) are omitted while the first gate contact 3 is used to connect the increased width portion of the gate electrode 2 for connecting the finger portions F and the portion 6A in the form of a rectangular framework of the gate wiring line. The drain wiring line 7 is formed from the 2MT.

In the structure example 1, the value C20 of the coupling capacitance between the drain wiring line 7 and the gate wiring line 6 is sufficiently lower than the value (C2+C11+C12) of the synthesized coupling capacitance shown in FIG. 16, and the high-frequency characteristics of the transistor are improved as much.

Meanwhile, the value C30 of the coupling capacitance between the drain wiring line 7 and the semiconductor substrate 1 in the structure example 1 is sufficiently lower than the value C3 of the coupling capacitance shown in FIG. 16 and the high-frequency characteristics of the transistor are improved as much because the distance between the drain wiring line 7 and the semiconductor substrate 1 is greater than that in the structure example shown in FIG. 16.

### STRUCTURE EXAMPLE 2

FIG. 19 shows a sectional view of a high-frequency transistor of the structure example 2 taken along a line same as the B-B line of FIG. 15.

In the structure example 2, in addition to the formation of the drain wiring line 7 as an upper layer than that of the gate wiring line 6, the contact portion of the drain region is optimized.

More particularly, the drain wiring line 7 formed from the 2MT is connected to the drain region DR formed on the semiconductor substrate 1 by a deep drain contact 8. The drain region DR is formed on the semiconductor substrate 1 by ion implantation performed using two adjacent finger portions F as a mask layer. The diameter of the deep drain contact 8 has a minimum dimension Wc relating to a contact of a semiconductor fabrication process used for the formation of the transistor. Meanwhile, the distance from the deep drain contacts 8 to the finger portions F is a minimum dimension Wc_c relating to the distance between a contact and another conductor layer in the semiconductor fabrication process. Accordingly, the width of the drain region DR is as small as (2Wc_c+Wc) and the occupation area of the transistor is reduced as much. It is to be noted that, if the distance between the finger portions F and the drain contacts 8 is reduced, then although the coupling capacitance at the portion increases, the influence of the increase of the coupling area on the frequency characteristics is comparatively little because the projected overlapping area when one of the finger portions F and the drain contacts 8 is viewed from the other in the horizontal direction originally is sufficiently smaller than the projected area where wiring lines cross with each other.

### STRUCTURE EXAMPLE 3

In the structure example 1 and the structure example 2, only it is necessary for the drain wiring line 7 to be formed as an upper layer than the gate wiring line 6, and such modification that the drain wiring line 7 is placed on a layered level higher than the third layer metal (3MT) is possible.

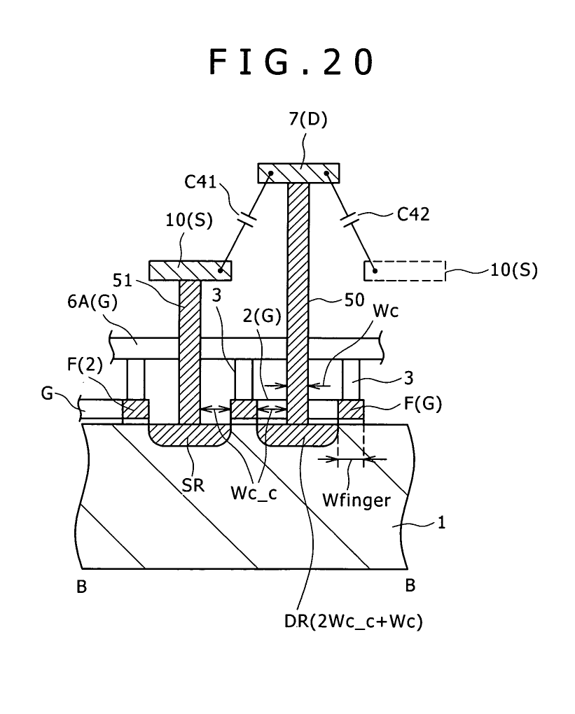

The structure example 3 is a modification to the structure example 2 in that the drain wiring line 7 is formed from the 3MT, and a sectional view thereof is shown in FIG. 20.

In the structure example 3, the coupling capacitances C41 and C42 between the drain wiring lines 7 and the source wiring line 10 are smaller than those in the case of FIG. 16. Therefore, there is the possibility that the high-frequency characteristics of the transistor of the structure example 3 may be further improved when compared with the structure example 1.

The present invention can be applied to a high-frequency transistor model which is incorporated in and used with such software as that for a simulation of a high-frequency circuit and a device simulation of a high-frequency transistor unit and represents a transistor unit on a computer.

While preferred embodiments of the present invention have been described using specific terms, such description is for illustrative purposes only, and it is to be understood that changes and variations may be made without departing from the spirit or scope of the following claims.

In the drawings:

[FIGS. 4A to 4D]

Actual measurement

[FIG. 5]

Gate width W

[FIG. 7]

Equal resistance plane

[FIG. 8]

Measurement

Extraction from S parameter

[FIG. 9]

measurement, calculation, simulation, separation calculation

Top left: intrinsic transistor section

start

ST1a: DC measurement, CV measurement

end

Top middle: extrinsic circuit section

start

ST2b: extraction of parasitic components (calculation)

ST3b: extraction of layout components (calculation)

ST5b: separation of NQS components (calculation)

end

Top right: parasitic circuit section

start

ST1c: DC measurement

ST3c: extraction of layout components (calculation), [also setting or Sim. is allowable]

ST5c: separation of electromagnetic effect components (calculation)

end

[FIG. 10]

Top: start

ST11: extraction of parameters from first layout

ST12: DC measurement on second layout→extraction of parameters

ST13: estimation of layout components→extraction of non-layout components

ST14: extraction of parameters from second layout

ST15: verification, prediction of S parameter, prediction of ft, fmax

Bottom: end

[FIG. 11A]

Layout change

[FIG. 11C]

Variation by change of finger length to twice

Per one finger

Overall

Twice+extracted amount

Four times+(extracted amount)×2

Twice

One time

Twice

One time

One time

½ time

Twice

Four times

[FIG. 12]

Gate resistance

Extracted amount

Rsub1 resistance

Extracted amount

[FIGS. 13A to 13D]

Actually measured value

Actually measured value

Actually measured value

Actually measured value

Frequency

Device

[FIG. 14]

Tr parameter

Parasitic capacitance (wiring line capacitance)

Gate leading out portion

Capacitance between wiring lines

Basis resistance

Inductor

Unit

Source of data

DC measurement

Calculated value+extracted value

DC measurement

Calculated value (device parameter)

DC measurement

Calculated value (device parameter)

Calculated value

Calculated value

Calculated value

Calculated value

Calculated value

Calculated value

Calculated value

Calculated value+extracted value

Calculated value

fg center value

fmax center value

Δ: measurement difference between frequencies where Wfinger is 5 μm and 1 μm

[FIG. 17]

Top: start

ST20: initialization of transistor section/wiring line section

ST21: measurement of sensitivity

ST22: determination of layer level

ST23: design of wiring line section

ST11 to ST15: optimization of parameters

Bottom: end

What is claimed is:

1. A designing method for a high-frequency transistor, which includes a transistor section having a source region, a drain region, and a gate electrode which are formed on a semiconductor substrate, a source wiring line connected to the source region, a drain wiring line connected to the drain region, and a gate wiring line connected to the gate electrode, for optimizing wiring lines and contacts from voltage supplying nodes of the source region, the drain region, and the gate electrode to electrode lead nodes of a transistor unit of a high-frequency semiconductor circuit, the method comprising the steps of:
measuring a sensitivity to a high-frequency characteristic of the high-frequency transistor regarding coupling capacities between the wiring lines including the gate wiring line, source wiring line, and drain wiring line and coupling capacities between the wiring lines and the semiconductor substrate from among equivalent circuit parameters which vary in response to a configuration of the wiring lines and the contacts;
deciding layered levels individually of the gate wiring line, source wiring line, and drain wiring line based on the measured sensitivities; and
designing patterns of the gate wiring line, source wiring line, and drain wiring line in the individually decided layered levels and the positions and the sizes of the wiring lines and the contacts for connecting the wiring lines and the transistor section to each other.

2. A designing method for a high-frequency transistor according to claim 1, wherein, where the drain wiring line is in an upper layer than that of the gate wiring line as a result of the decision at the level deciding step, a minimum dimension of a semiconductor fabrication process is applied to the dimension of the drain contact for connecting the drain wiring line to the drain region and the distance between the drain contact and the gate wiring line at the wiring line section designing step.

3. A designing method for a high-frequency transistor according to claim 1, wherein, where the coupling capacitance between the drain wiring line and the semiconductor substrate is to be reduced as a result of the measurement at the sensitivity measuring step, the layered levels of the wiring lines are decided at the level deciding step so that the drain wiring line is in an upper layer than that of the gate wiring line.

4. A designing method for a high-frequency transistor according to claim 1, wherein, where the coupling capacitance between the drain wiring line and the source wiring line is to be reduced as a result of the measurement at the sensitivity measuring step, the layered levels of the wiring lines are decided at the level deciding step so that the layers of the source wiring line and the drain wiring line are different from each other.

5. A designing method for a high-frequency transistor according to claim 1, further comprising the step of designing the transistor section, and wherein at least one of a correction value for the resistance value of the semiconductor substrate and a correction value for the coupling capacitance between the drain wiring line and the semiconductor substrate is determined such that, under the coupling capacitance value between the drain wiring line and the semiconductor substrate used at the sensitivity measuring step, where power consumption has a maximum value in a series circuit of the coupling capacitance and the resistance of the semiconductor substrate, the power consumption decreases from the maximum value, and the determined correction value is reflected on at least one of the transistor designing step, sensitivity measuring step, and connection section designing step.

6. A designing method for a high-frequency transistor according to claim 1, wherein, at the sensitivity measuring step, the sensitivity of a layout parameter to the high-frequency characteristic is measured from a result of a simulation which is performed by variously changing the layout parameter using, as a high-frequency transistor model for representing the high-frequency transistor on a computer upon simulation of a high-frequency characteristic, a high-frequency transistor model which includes an intrinsic transistor section of the high-frequency transistor and a parasitic circuit which is connected to the intrinsic transistor section and includes the layout parameter which varies in response to change of the layout of the electrodes, wiring lines, and contacts of the transistor unit.

7. A designing method for a high-frequency transistor according to claim 6, wherein the high-frequency transistor model further includes an extrinsic circuit which is connected to the intrinsic transistor section and includes a non-quasi-static parameter indicating a time delay of carriers traveling in a channel of the high-frequency transistor.

8. A designing method for a high-frequency transistor according to claim 6, wherein the parasitic circuit includes a coupling capacitance between the semiconductor substrate and the source wiring line, a coupling capacitance between the semiconductor substrate and the drain wiring line, in-substrate resistances and in-substrate capacitances from the coupling capacities to a reference potential of the semiconductor substrate, a coupling capacitance between the gate wiring line and the drain wiring line, and a coupling capacitance between the gate wiring line and the source wiring line.

9. A designing method for a high-frequency transistor according to claim 6, wherein the gate-drain capacitance and the gate-source capacitance which are parameters of the intrinsic transistor section have a bias dependency.

10. A designing method for a high-frequency transistor according to claim 1, wherein the gate electrode of the high-frequency transistor has a plurality of finger portions which individually function as effective gate portions.

11. A high-frequency transistor having a multi-finger gate, comprising:
a transistor section having a source region and a drain region as well as a gate electrode having multi-fingers, all formed on a semiconductor substrate;
a source wiring line connected to said source region;
a drain wiring line connected to said drain region; and
a gate wiring line connected to said gate electrode;
said drain wiring line being disposed in an upper layer than that of said gate wiring line while a minimum dimension of a semiconductor fabrication process is applied to the dimension of a drain contact for connecting said drain wiring line to said drain region and the distance between said drain contact and said gate wiring line in order to reduce a coupling capacitance between said drain wiring line and said semiconductor substrate.

12. A high-frequency transistor having a multi-finger gate, comprising:
a transistor section having a source region and a drain region as well as a gate electrode having multi-fingers, all formed on a semiconductor substrate;
a source wiring line connected to said source region;
a drain wiring line connected to said drain region; and
a gate wiring line connected to said gate electrode;
said drain wiring line being disposed in an upper layer than that of said gate wiring line in order to reduce a coupling capacitance between said drain wiring line and said gate wiring line.

13. A high-frequency transistor having a multi-finger gate, comprising:
a transistor section having a source region and a drain region as well as a gate electrode having multi-fingers, all formed on a semiconductor substrate;
a source wiring line connected to said source region;
a drain wiring line connected to said drain region; and
a gate wiring line connected to said gate electrode;
said source wiring line and said drain wiring line being disposed in layers different from each other in order to reduce a coupling capacitance between said drain wiring line and said source wiring line.

14. A high-frequency transistor having a multi-finger gate, comprising:
a transistor section having a source region and a drain region as well as a gate electrode having multi-fingers, all formed on a semiconductor substrate;
a source wiring line connected to said source region;
a drain wiring line connected to said drain region; and
a gate wiring line connected to said gate electrode;
at least one of the resistance value of said semiconductor substrate and the coupling capacitance between each of the wiring lines and said semiconductor substrate being determined such that, under the coupling capacitance value between said gate wiring line, drain wiring line, or source wiring line and said semiconductor substrate, where power consumption has a maximum value in a series circuit of the coupling capacitance and the resistance of said semiconductor substrate, the power consumption decreases from the maximum value.
